(19) United States
(12) Patent Application Publication
(10) Pub. No.: US 2015/0095572 A1
(43) Pub. Date: Apr. 2, 2015

(54) STORAGE CONTROL APPARATUS AND STORAGE CONTROL METHOD

(71) Applicant: FUJITSU LIMITED, Kawasaki-shi (JP)

(72) Inventor: Shigeaki Koike, Kawasaki (JP)

(21) Appl. No.: 14/565,491

(22) Filed: Dec. 10, 2014

Related U.S. Application Data
(63) Continuation of application No. PCT/JP2012/066140, filed on Jun. 25, 2012.

(51) Int. Cl. G06F 3/06

(52) U.S. Cl. CPC G06F 3/0625; G06F 3/064; G06F 3/0689
USPC 711/114

(57) ABSTRACT

An operation controller stops the operation of two or more storage devices among a plurality of storage devices constituting one or more logical storage areas. When writing of data to a stopped storage device among the storage devices constituting each logical storage area is requested, an access controller performs control to maintain data redundancy in each logical storage area by working storage devices among the storage devices constituting each logical storage area and by a spare storage device that is different from the storage devices constituting each logical storage area, by writing the data in the spare storage device instead of the storage device to which the writing is requested.

### CROSS-REFERENCE TO RELATED APPLICATION

This application is a continuation application of International Application PCT/JP2012/066140 filed on Jun. 25, 2012 which designated the U.S., the entire contents of which are incorporated herein by reference.

### FIELD

The embodiments discussed herein relate to storage control apparatuses and storage control methods.

### BACKGROUND

In recent years, storage systems using a plurality of storage devices, such as HDDs (Hard Disk Drives), are widely used. In such a storage system, a storage control is usually performed, in which data is made redundant in two or more storage devices by using a RAID (Redundant Arrays of Inexpensive Disks) technique, whereby the safety of stored data is improved.

The storage system using the RAID technique includes a large number of storage devices and accordingly has a problem that the power consumption increases. In contrast, there is known a system including a storage device for operation volume and a storage device for replication, in which the power supply of the storage device for replication is turned off during normal operation, and then the power supply of the storage device for replication is turned on at a predetermined timing to perform replication.

Many of the storage systems using the RAID technique include a spare storage device, referred to as “hot spare”. In such a storage system, if one storage device fails, the data having been stored in the failed storage device is rebuilt and stored in the hot spare storage device. Thus, the operation of the storage system may be resumed in a short time.

The examples of the technique using the hot spare storage device include a technique which writes a part of the data stored in a plurality of storage devices controlled by RAID also in the hot spare storage device in advance, and then in reading data, performs reading not only from each storage device controlled by RAID but also from the hot spare storage device, thereby speeding up the reading.

See, for example, Japanese Laid-open Patent Publication No. 2004-326244 and Japanese Laid-open Patent Publication No. 2003-108316.

As described above, the storage system using the RAID technique has a problem that the power consumption increases. In contrast, as described above, in the technique in which the power supply of the storage device for replication is kept turned off during normal operation, data will not be made redundant until the power supply of the storage device for replication is turned on.

### SUMMARY

According to an aspect of the embodiments disclosed herein, there is provided a storage control apparatus that controls writing of data to each of one or more logical storage areas each including storage areas of a plurality of storage devices so that the data is made redundant for said each logical storage area in different storage devices, the storage control apparatus including a processor configured to perform a procedure including: stopping an operation of a plurality of storage devices among the storage devices constituting said each logical storage area; when writing of data to a stopped storage device is requested among the storage devices constituting said each logical storage area, performing control to maintain data redundancy in said each logical storage area by working storage devices among the storage devices constituting said each logical storage area and by a spare storage device that is different from the storage devices constituting said each logical storage area, by writing the data in the spare storage device instead of the storage device to which the writing is requested.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a storage system according to a first embodiment and an operation example thereof;

FIG. 2 illustrates a configuration example of a storage system according to a second embodiment;

FIG. 3 illustrates an example of the internal configuration of an array controller;

FIG. 4 illustrates a first setting example of RAID groups;

FIG. 5 illustrates the control of RAID 5;

FIG. 6 illustrates a second setting example of a RAID group;

FIG. 7 illustrates the control of RAID 6;

FIG. 8 illustrates a third setting example of a RAID group;

FIG. 9 illustrates the control of RAID 1+0;

FIG. 10 is a block diagram illustrating the configuration example of the processing functions of an array controller;

FIG. 11 illustrates an example of the contents of information that are utilized in processing of the array controller;

FIG. 12 is a flow chart illustrating an example of access control processing performed by a RAID controller;

FIG. 13 is a flow chart illustrating an example of the access control processing performed by the RAID controller;

FIG. 14 is the flow chart illustrating an example of write processing in the case of RAID 1 or RAID 1+0;

FIG. 15 is the flow chart illustrating an example of the write processing in the case of RAID 5 or RAID 6;

FIG. 16 is the flow chart illustrating an example of write back processing from a hot spare HDD;

FIG. 17 is the flow chart illustrating a first example of start processing of the array controller;

FIG. 18 is the flow chart illustrating a second example of the start processing of the array controller;

FIG. 19 is the flow chart illustrating an example of recovery processing when a hot spare HDD has failed;

FIG. 20 is the flow chart illustrating an example of recovery processing when a working HDD among the HDDs constituting a RAID group has failed; and

FIG. 21 is the flow chart illustrating an example of the recovery processing when a stopped HDD has failed.

### DESCRIPTION OF EMBODIMENTS

Embodiments of the present invention will be described below with reference to the accompanying drawings, wherein like reference numerals refer to like elements throughout.

### First Embodiment

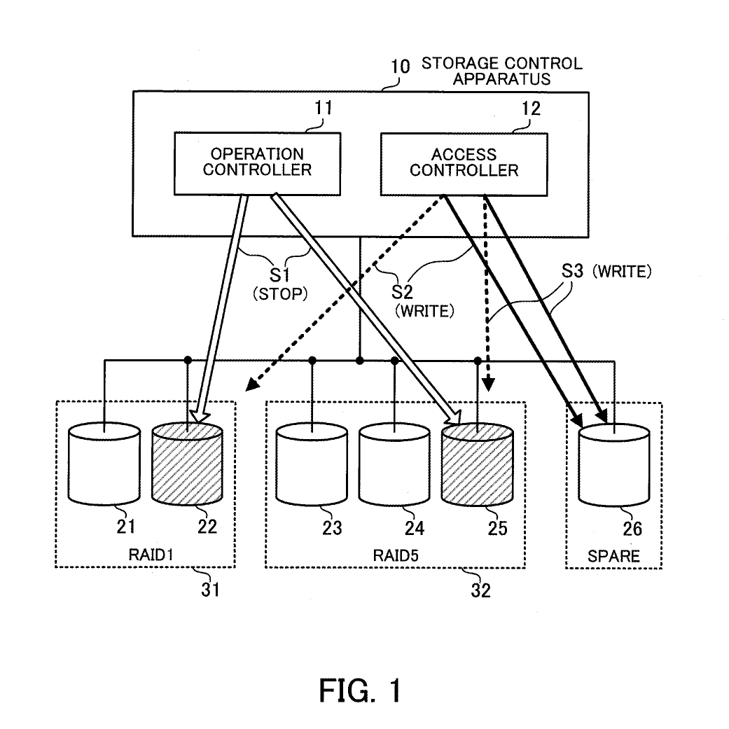

FIG. 1 illustrates a configuration example of a storage system according to a first embodiment and an operation example thereof. The storage system illustrated in FIG. 1 includes a storage control apparatus 10 and a plurality of storage devices. The storage system of FIG. 1 includes six storage devices 21 to 26 as an example.

The storage control apparatus 10 controls the access to the storage devices 21 to 26. Moreover, the storage control apparatus 10 may manage storage areas of a plurality of storage devices as one logical storage area. The storage control apparatus 10 controls the writing of data to each logical storage area so that data is made redundant for each logical storage area in different storage devices. Management of such a logical storage area is performed using a RAID technique. The logical storage area is referred to as a RAID group or the like.

In the example of FIG. 1, the storage areas of the storage devices 21 and 22 are managed as a logical storage area 31 and the storage areas of the storage devices 23 to 25 are managed as a logical storage area 32. The reading and writing of data from and to the logical storage area 31 are controlled by RAID 1, for example. In this case, the storage control apparatus 10 writes the same data to both the storage devices 21 and 22 so as to mirror the data to the storage devices 21 and 22. Moreover, the reading and writing of data from and to the logical storage area 32 are controlled by RAID 5, for example. In this case, the storage control apparatus 10 divides the data to be written in the logical storage area 32, and distributes and writes consecutive two pieces of divided data and parities based on these data in the areas having the same stripe number in the storage devices 23 to 25.

Moreover, at least one of the storage devices connected to the storage control apparatus 10 is made to serve as a spare storage device. In the example of FIG. 1, the storage device 26 is prepared for a spare. When for example one of the storage devices constituting any one of the logical storage areas has failed, the spare storage device 26 instead of the failed storage device is incorporated into a logical storage area for use. Thus, a logical storage area, in which data is temporarily non-redundant due to a failure of a storage device, may be recovered in a short time to a state where the data is redundant.

The storage control apparatus 10 includes an operation controller 11 and an access controller 12.

The operation controller 11 stops the operation of a plurality of storage devices among the storage devices constituting the respective logical storage areas 31 and 32 in order to reduce the power consumption of the whole storage system. In the example of FIG. 1, as illustrated as step S1, the operation controller 11 stops the operations of the storage device 22 and storage device 25. Note that, for example, when the storage devices 22 and 25 are HDDs, the operation controller 11 stops the operations of the storage devices 22 and 25 by stopping the rotation of the magnetic disk in each of the storage devices 22 and 25 or by turning off the power supply of each of the storage devices 22 and 25.

When writing of data to a stopped storage device among the storage devices constituting the respective logical storage areas 31 and 32 is requested, the access controller 12 writes the data in the spare storage device 26 instead of the storage device to which the writing is requested. For example, as illustrated as step S2 in FIG. 1, when writing of data to the storage device 22 is requested, the access controller 12 writes the data in the spare storage device 26 instead of the storage device 22. Moreover, as illustrated as step S3 of FIG. 1, when writing of data to the storage device 25 is requested, the access controller 12 writes the data in the spare storage device 26 instead of the storage device 25.

Note that a data writing request for the access controller 12 may be transmitted from an external host device connected to the storage control apparatus 10 or may be generated inside the storage control apparatus 10, for example.

By writing as described above, the access controller 12 controls to maintain data redundancy in each of the logical storage areas 31 and 32 by the working storage devices 21, 23, and 24 among the storage devices constituting the respective logical storage areas 31 and 32 and by the spare storage device 26.

Here, a storage device whose operation is to be stopped by the operation controller 11 is determined such that the data of a logical storage device, to which the storage device belongs, is not lost when the operation of the storage device stops. The state where “the data of a logical storage device is not lost” as referred to herein indicates a state where the data may be read only from a working storage device among the storage devices constituting the logical storage device or a state where the data may be rebuilt using parities.

For example, in a logical storage area managed by RAID 1, RAID 4, and RAID 5, the operation of only one of the storage devices constituting the logical storage area may be stopped. Moreover, in a logical storage area managed by RAID 6, the operations of up to two storage devices among the storage devices constituting the logical storage area may be stopped.

Because a storage device whose operation is to be stopped is determined in this manner, the access controller 12 may control, in selecting the storage device whose operation is to be stopped, to maintain data redundancy in each of the logical storage areas by a working storage device among the storage devices constituting each logical storage area and by a spare storage device.

Furthermore, the operation controller 11 stops the operations of a greater number of storage devices than that of spare storage devices that are used as a writing destination by the access controller 12, among the storage devices constituting each logical storage area. Thus, the power consumption in the storage system may be reduced.

According to the above-described processing performed by the storage control apparatus 10, data may be made redundant with a lower power consumption.

Note that, the storage control apparatus 10 may write back at a predetermined timing the data, which was written in the spare storage device 26, to an original write position in the storage areas of the storage devices constituting each logical storage area. The storage control apparatus 10 writes back data, for example, when the remaining capacity of the spare storage device 26 becomes not larger than a predetermined threshold or when one storage device constituting any one of logical storage areas has failed and accordingly the spare storage device 26 needs to be used instead of the failed storage device.

### Second Embodiment

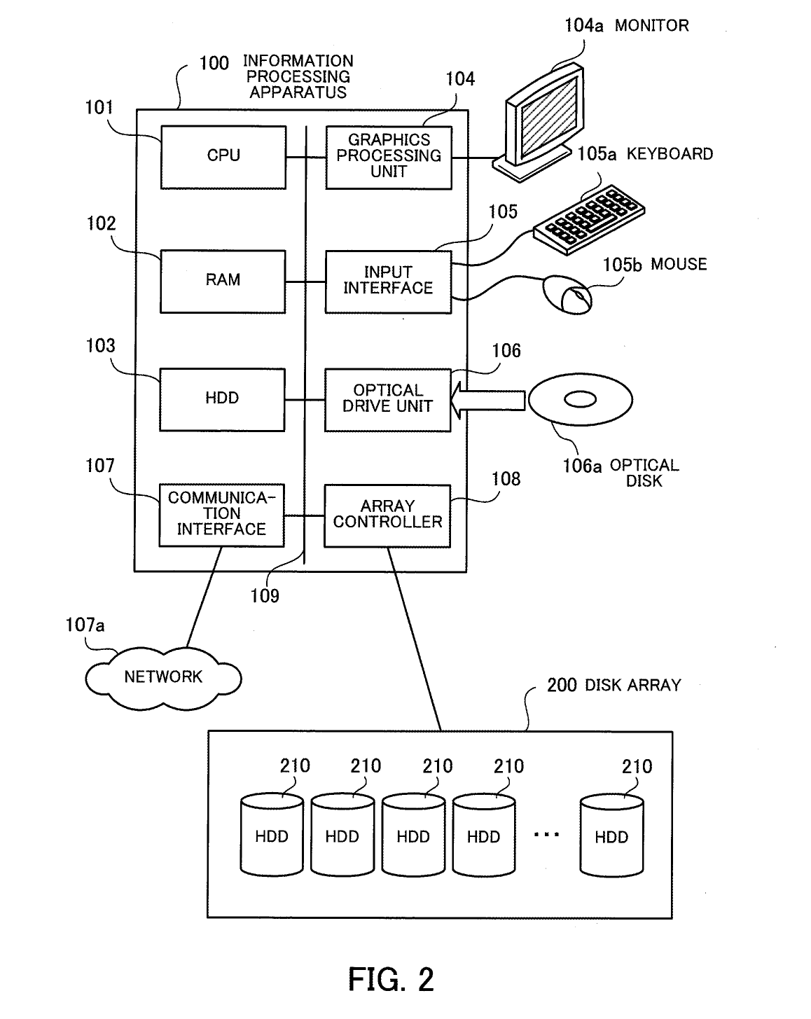

FIG. 2 illustrates a configuration example of a storage system according to a second embodiment. The storage system illustrated in FIG. 2 includes an information processing apparatus 100 and a disk array 200.

The disk array 200 includes a plurality of storage devices to be accessed from the information processing apparatus 100. In the embodiment, the disk array 200 includes an HDD 210 as a storage device to be accessed from the information processing apparatus 100, but may include, for example, a nonvolatile storage device, such as an SSD (Solid State Drive), other than an HDD. Moreover, a plurality of disk arrays 200 may be connected to the information processing apparatus 100.

The information processing apparatus 100 may read and write data from and to the HDD 210 in the disk array 200. The information processing apparatus 100 has the following hardware configuration.

The information processing apparatus 100 may be implemented as a computer as illustrated in FIG. 2. The whole information processing apparatus 100 is controlled by a CPU (Central Processing Unit) 101. A RAM (Random Access Memory) 102 and a plurality of peripheral devices are connected to the CPU 101 via a bus 109.

The RAM 102 is used as the main storage unit of the information processing apparatus 100. At least part of the program of an OS (Operating System) and application programs executed by the CPU 101 are temporarily stored in the RAM 102. Moreover, various types of data needed for processing by the CPU 101 are stored in the RAM 102.

The peripheral devices connected to the bus 109 include an HDD (Hard Disk Drive) 103, a graphics processing unit 104, an input interface 105, an optical drive unit 106, a communication interface 107, and an array controller 108.

The HDD 103 magnetically writes and reads data to and from a built-in magnetic disk. The HDD 103 is used as a secondary storage unit of the information processing apparatus 100. The OS program, application program, and various types of data are stored in the HDD 103. Note that another type of nonvolatile semiconductor memory, such as a flash memory, may be used as the secondary storage unit.

A monitor 104a is connected to the graphics processing unit 104. The graphics processing unit 104 displays an image on the monitor 104a in accordance with an instruction from the CPU 101. Note that the monitor 104a is a liquid crystal display, for example.

Input devices, such as a keyboard 105a and a mouse 105b, are connected to the input interface 105. The input interface 105 transmits an output signal from the input device to the CPU 101.

The optical drive unit 106 reads the data recorded on the optical disk 106a using a laser beam or the like. The optical disk 106a is a portable recording medium on which data is recorded so as to be readable by reflection of light. The examples of the optical disk 106a include a DVD (Digital Versatile Disc), a DVD-RAM, a CD-ROM (Compact Disc Read Only Memory), a CD-R (Recordable)/RW (Rewritable), and the like.

The communication interface 107 transmits and receives data to and from other devices through a network 107a.

The array controller 108 controls the access to the HDD 210 inside the disk array 200 in accordance with an instruction from the CPU 101. The array controller 108 may control the HDD 210 inside the disk array 200 using RAID.

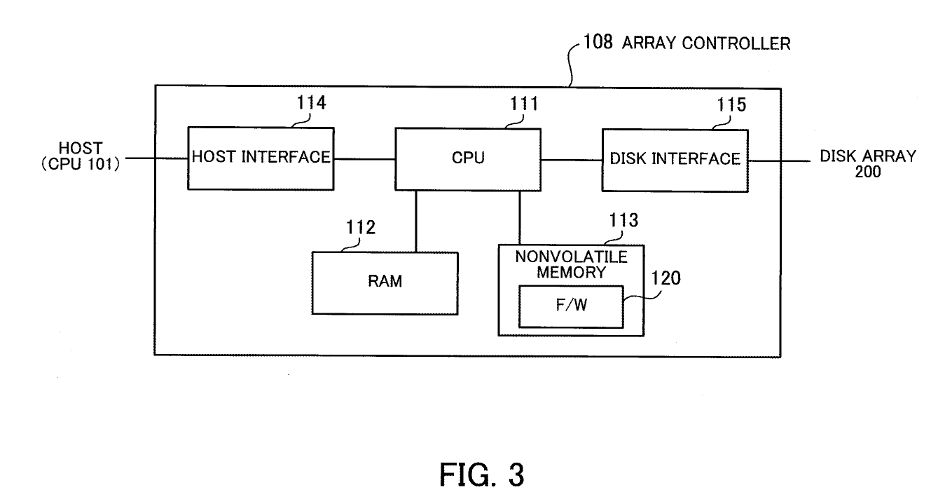

FIG. 3 illustrates an example of the internal configuration of the array controller. The array controller 108 includes a CPU 111, a RAM 112, a nonvolatile memory 113, a host interface 114, and a disk interface 115.

The CPU 111 controls the access to the HDD 210 inside the disk array 200 by executing a firmware (F/W) 120 stored in the nonvolatile memory 113. At least part of the firmware 120 executed by the CPU 111 and various types of data are temporarily stored in the RAM 112.

The host interface 114 transmits and receives data between a host and the CPU 111. The host is the CPU 101 of the information processing apparatus 100. The disk interface 115 transmits and receives data between the HDD 210 inside the disk array 200 and the CPU 111. The disk interface 115 may transmit commands to the HDD 210 inside the disk array 200 under control of the CPU 111.

The CPU 111 may manage a plurality of HDDs 210 mounted on the disk array 200, as a RAID group. The RAID group is a logical storage area which includes storage areas of a plurality of HDDs 210 and which is managed such that data is made redundant in different HDDs 210. The information about the HDDs 210 constituting each RAID group, the information about a RAID level that is used in managing each RAID group, and the like are set in the nonvolatile memory 113.

Next, the access control to the HDD 210 by the array controller 108 is described.

The array controller 108 uses at least one of the HDDs 210 mounted on the disk array 200, as a spare HDD, referred to as a “hot spare”. Moreover, the array controller 108 stops the rotations of the magnetic disks in a plurality of predetermined HDDs 210 among the HDDs 210 constituting each RAID group.

When writing of data to the HDD 210 in which the rotation of the magnetic disk has been stopped is requested, the array controller 108 temporarily writes the data to the hot spare HDD. The array controller 108 controls to maintain data redundancy, using HDDs, in which the rotations of the magnetic disks are not stopped among the HDDs 210 constituting each RAID group, and the hot spare HDD. Thus, the power consumption of the whole storage system may be reduced and also the data stored in each RAID group may be made redundant.

Hereinafter, a setting example of RAID groups and an example of selecting an HDD, in which the rotation of the magnetic disk is to be stopped, are taken.

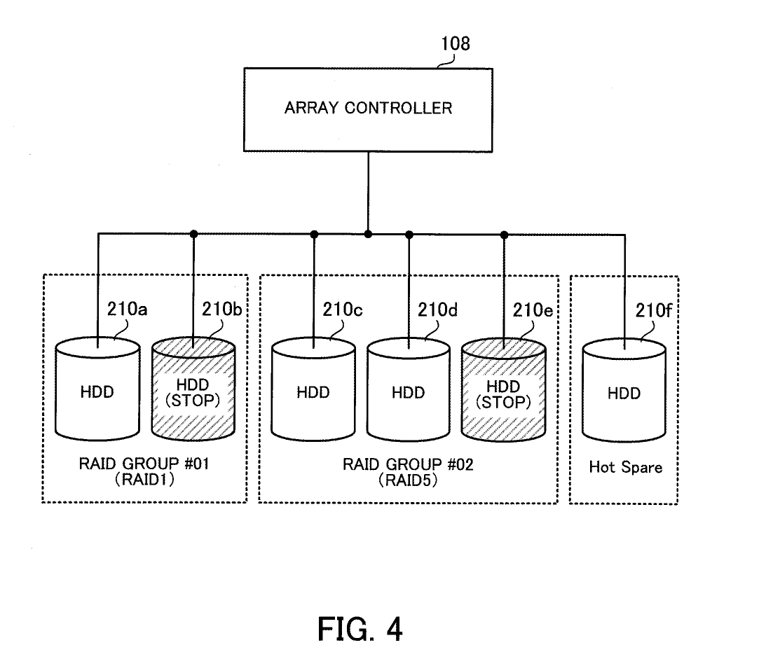

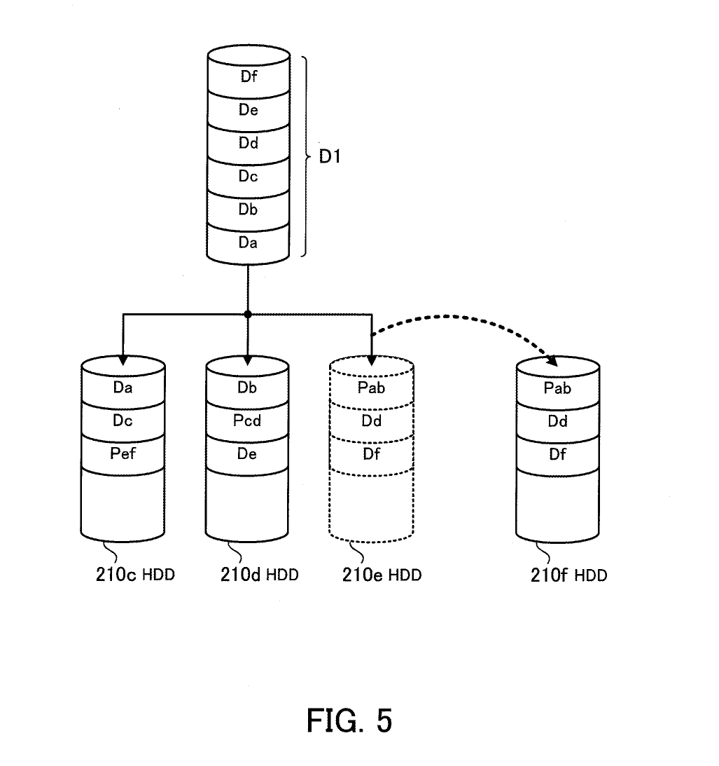

First, FIG. 4 illustrates a first setting example of RAID groups. Moreover, FIG. 5 illustrates the control of RAID 5.

In the example of FIG. 4, among the HDDs mounted on the disk array 200, a RAID group #01 is constituted by the storage areas of the HDDs 210a and 210b, and a RAID group #02 is constituted by the storage areas of the HDDs 210c to 210e. Moreover, the HDD 210f is used as a hot spare, and also used as a temporary storage area of the data that is to be written in an HDD, in which the rotation of a magnetic disk has been stopped, among the HDDs 210a to 210e constituting the RAID groups #01 and #02.

The RAID group #01 is managed by RAID 1, for example. RAID 1 is a scheme in which the same data is written in two HDDs so as to mirror the data to the respective HDDs. When received from the host a data writing request to a logical volume corresponding to the RAID group #01, the array controller 108 writes the data requested to be written, to both the HDDs 210a and 210b. Moreover, when received from the host a data reading request from a logical volume corresponding to the RAID group #01, the array controller 108 reads the data from a predetermined one of the HDDs 210a and 210b. In the embodiment, the data is assumed to be read from the HDD 210a.

The RAID group #02 is managed by RAID 5, for example. RAID 5 is a scheme in which write data is divided into pieces of fixed-length data and then the consecutive pieces of divided data and parities based on these data are distributed and written in the areas having the same stripe number in a plurality of HDDs.

For example, as illustrated in FIG. 5, assume that the array controller 108 is requested from the host to write data D1 to a logical volume corresponding to the RAID group #02. Then, the array controller 108 divides the data D1 for each predetermined data length to generate pieces of divided data Da to Df.

The array controller 108 calculates a parity Pab from the pieces of divided data Da and Db, a parity Pcd from the pieces of divided data Dc and Dd, and a parity Pef from the pieces of divided data De and Df, respectively. The array controller 108 writes the pieces of divided data Da and Db and the parity Pab to the HDDs 210c, 210d, and 210e, respectively, and writes the divided data Dc, the parity Pcd, and the divided data Dd to the HDDs 210c, 210d, and 210e, respectively, and writes the parity Pef and the pieces of divided data De and Df to the HDDs 210c, and 210d and 210e, respectively. Thus, in the consecutive stripes, parities are distributed and stored in different HDDs.

In the example of FIG. 4, one hot spare HDD 210f is used as the temporary storage area of the data to be written in an HDD in which the rotation of the magnetic disk has been stopped. In this case, the power consumption may be reduced by stopping the rotations of the magnetic disks in two or more HDDs among the HDDs constituting a RAID group.

On the other hand, in the RAID group #01 managed by RAID 1, even if the operation of one of the HDDs 210a and 210b constituting the RAID group #01 is stopped, the data in the RAID group #01 will not be lost. Moreover, in the RAID group #02 managed by RAID 5, even if the operation of one of the HDDs 210c to 210e constituting the RAID group #02 is stopped, the data in the RAID group #02 will not be lost. The state where “the data in a RAID group will not be lost” as referred to herein indicates a state where the divided data already stored in the RAID group may be read as it is or may be rebuilt and also a state where the data to be subsequently written in the RAID group also will not be lost.

Then, in the example of FIG. 4, the array controller 108 stops the rotations of the magnetic disks in a total of two HDDs, i.e., one of the HDDs 210a and 210b constituting the RAID group #01 and one of the HDDs 210c to 210e constituting the RAID group #02. As an example, the array controller 108 stops the rotation of the magnetic disk in each of the HDDs 210b and 210e.

Moreover, the array controller 108 continues to receive an access to a logical volume corresponding to each of the RAID groups #01 and #02 in a state where the rotation of the magnetic disk in each of the HDDs 210b and 210e is stopped. When data is written to the HDD 210b, the array controller 108 temporarily writes the data to the hot spare HDD 210f without writing the data to the HDD 210b. Moreover, when data is written to the HDD 210e, the array controller 108 temporarily writes the data to the hot spare HDD 210f without writing the data to the HDD 210e. Note that, in the example of FIG. 5, the parity Pab and pieces of divided data Dd and Df to be written in the HDD 210e are written in the hot spare HDD 210f instead of the HDD 210e.

In this manner, the array controller 108 stops the rotation of the magnetic disk in each of the HDDs 210b and 210e, and temporarily writes to the hot spare HDD 210f the data to be written in the HDDs 210b and 210e. Thus, the array controller 108 may make the data redundant with a lower power consumption.

Note that another RAID level that may be managed by the array controller 108 is RAID 4. RAID 4, as with RAID 5, is a scheme in which write data is divided into pieces of fixed-length data and then the consecutive pieces of divided data and parities based on these data are written in the areas having the same stripe number in a plurality of HDDs. However, unlike RAID 5, the parity is written in the same HDD.

In such a RAID group managed by RAID 4, as with the case of RAID 5, one of the HDDs constituting the RAID group may be stopped. The array controller 108 stops the rotation of the magnetic disk in an HDD in which the parity is to be stored, and temporarily stores the parity in the hot spare HDD, for example. Thus, the data of the RAID group may be made redundant.

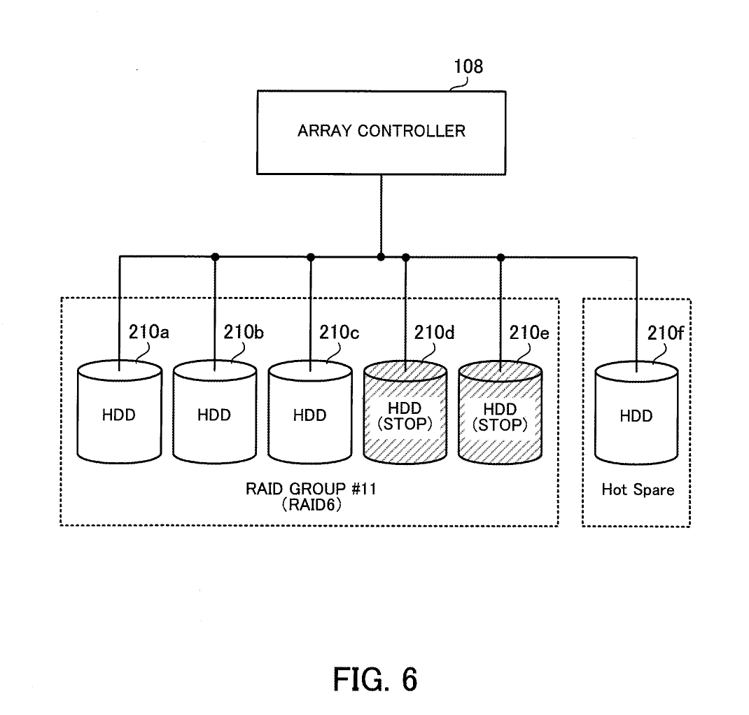

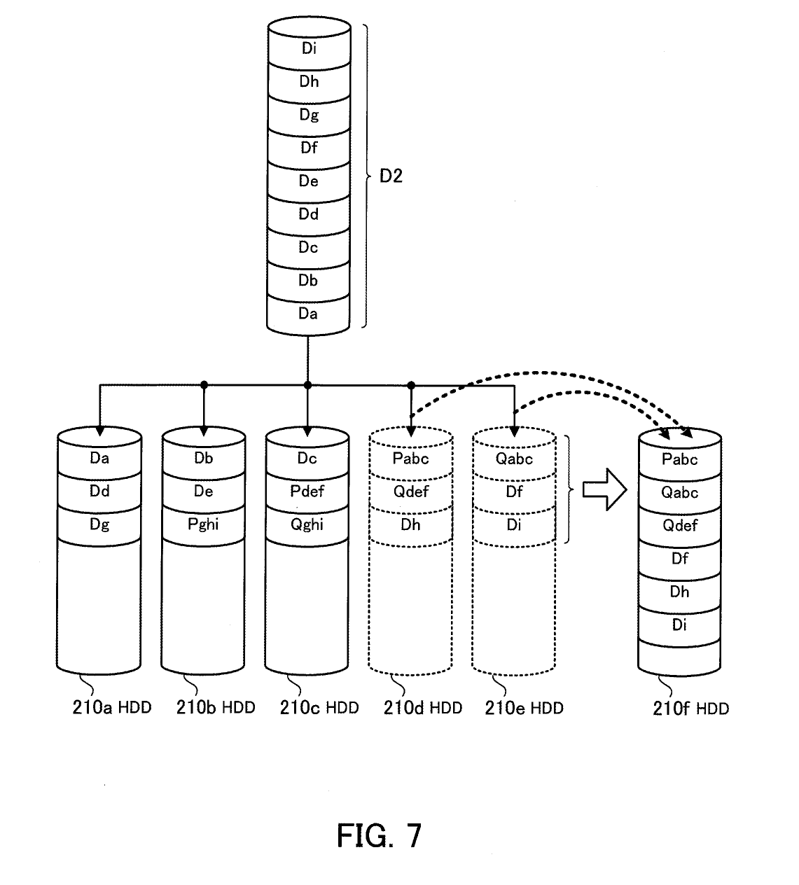

FIG. 6 illustrates a second setting example of a RAID group. Moreover, FIG. 7 illustrates the control of RAID 6.

In the example of FIG. 6, a RAID group #11 is constituted by the storage areas of the HDDs 210a to 210e among the HDDs mounted on the disk array 200. Moreover, the HDD 210f is used as the hot spare, and also used as a temporary storage area of the data to be written in an HDD, in which the rotation of the magnetic disk has been stopped, among the HDDs 210a to 210e constituting the RAID groups #11.

The RAID group #11 is managed by RAID 6, for example. RAID 6 is a scheme in which write data is divided into pieces of fixed-length data and then pieces of the consecutive divided data and two types of parties (P-parity and Q-parity) based on these data are distributed and written in the areas having the same stripe number in a plurality of HDDs.

For example, as illustrated in FIG. 7, assume that the array controller 108 is requested from the host to write data D2 to a logical volume corresponding to the RAID group #11. Then, the array controller 108 divides the data D2 for each predetermined data length to generate pieces of divided data Da to Di.

The array controller 108 calculates a P-parity Pabc and a Q-parity Qabc from the pieces of divided data Da to Dc, a P-parity Pdef and a Q-parity Qdef from the pieces of divided data Dd to Df, and a P-parity Pghi and a Q-parity Qghi from the pieces of divided data Dg to Di, respectively.

The array controller 108 writes the pieces of divided data Da, Db, and Dc and the P-parity Pabc and Q-parity Qabc to the HDDs 210a, 210b, 210c, 210d and 210e, respectively, writes the pieces of divided data Dd and De, the P-parity Pdef, the Q-parity Qdef, and the divided data Df to the HDDs 210a, 210b, 210c, 210d and 210e, respectively, and writes the divided data Dg, the P-parity Pghi, the Q-parity Qghi, the pieces of divided data Dh and Di to the HDDs 210a, 210b, 210c, 210d, and 210e, respectively. Thus, in the consecutive stripes, the P-parities and Q-parities are distributed and stored in different HDDs, respectively.

In the example of FIG. 6, as with the case of FIG. 4, one hot spare HDD 210f is used as the temporary storage area of the data to be written in an HDD in which the rotation of the magnetic disk has been stopped. In this case, the power consumption may be reduced by stopping the rotations of the magnetic disks in two or more HDDs among the HDDs constituting the RAID group. On the other hand, in the RAID group #11 managed by RAID 6, even if the operations of two of the HDDs 210a to 210e constituting the RAID group #11 are stopped, the data in the RAID group #11 will not be lost.

Then, in the example of FIG. 6, the array controller 108 stops the rotations of the magnetic disks in two of the HDDs 210a to 210e constituting the RAID group #11. As an example, the array controller 108 stops the rotation of the magnetic disk in each of the HDDs 210d and 210e.

Moreover, the array controller 108 continues to receive an access to logical volumes each corresponding to the RAID group #11 in a state where the rotation of the magnetic disk in each of the HDDs 210d and 210e is stopped. When data is written to the HDDs 210d and 210e, the array controller 108 temporarily writes the data to the hot spare HDD 210f without writing the data in the HDDs 210d and 210e.

In the example of FIG. 7, the P-parity Pabc, Q-parity Qdef, and divided data Dh to be written in the HDD 210d are written in the hot spare HDD 210f instead of the HDD 210d. Moreover, the Q-parity Qabc and pieces of divided data Df and Di to be written in the HDD 210e are written in the hot spare HDD 210f instead of the HDD 210e.

In this manner, the array controller 108 stops the rotation of the magnetic disk in each of the HDDs 210d and 210e, and temporarily writes to the hot spare HDD 210f the data to be written in the HDDs 210d and 210e. Thus, the array controller 108 may make the data redundant with a lower power consumption.

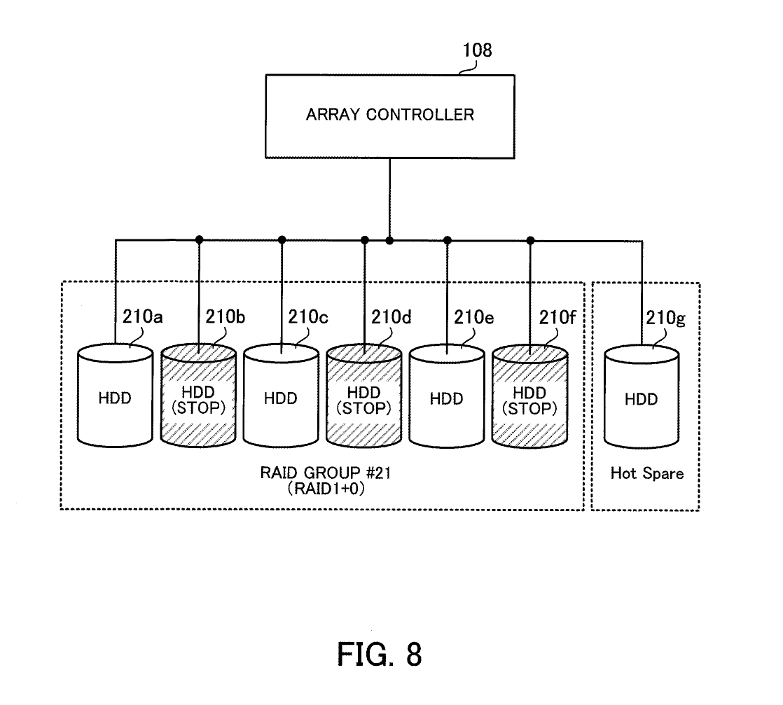

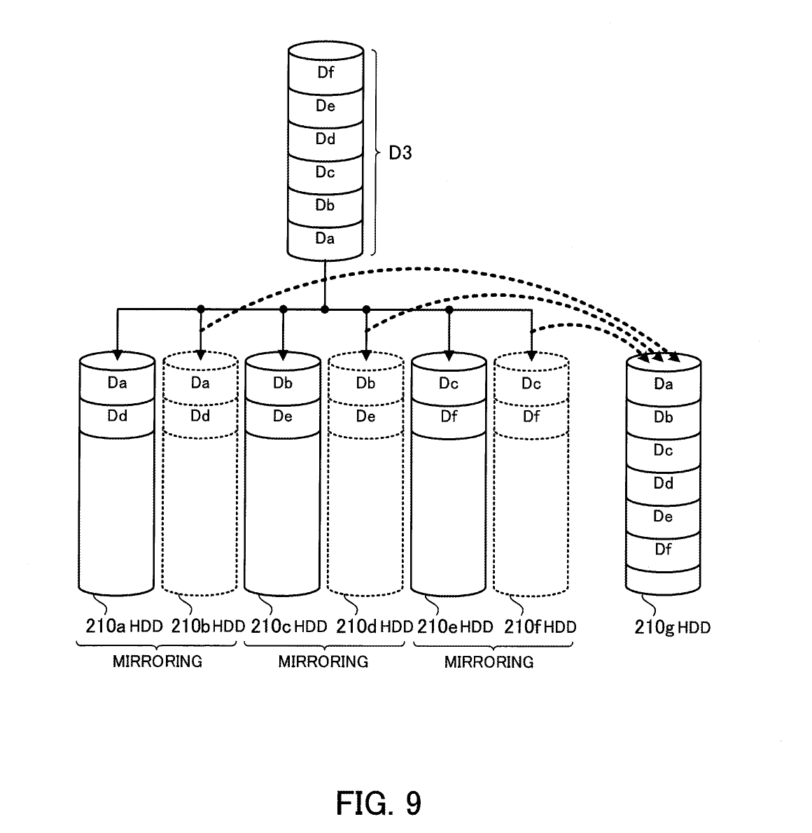

FIG. 8 illustrates a third setting example of a RAID group. Moreover, FIG. 9 illustrates the control of RAID 1+0.

In the example of FIG. 8, a RAID group #21 is constituted by the storage areas of HDDs 210a to 210f among the HDDs mounted on the disk array 200. Moreover, an HDD 210g is used as the hot spare, and also used as a temporary storage area of the data to be written in an HDD, in which the rotation of the magnetic disk has been stopped, among the HDDs 210a to 210f constituting the RAID groups #21.

The RAID group #21 is managed by RAID 1+0, for example. RAID 1+0 is a scheme in which data striping and data mirroring are combined. For example, as illustrated in FIG. 9, assume that the array controller 108 is requested from the host to write data D3 to a logical volume corresponding to the RAID group #21. Then, the array controller 108 divides the data D3 for each predetermined data length to generate pieces of divided data Da to Df.

The array controller 108 writes and mirrors the pieces of divided data Da to Dc to the areas having the same stripe number. Similarly, the array controller 108 writes and mirrors the pieces of divided data Dd to Df to the areas having the same stripe number. Specifically, the array controller 108 writes the divided data Da to the HDDs 210a and 210b, writes the divided data Db to the HDDs 210c and 210d, and writes the divided data Dc to the HDDs 210e and 210f. Moreover, the array controller 108 writes the divided data Dd to the HDDs 210a and 210b, writes the divided data De to the HDDs 210c and 210d, and writes the divided data Df to the HDDs 210e and 210f.

Note that, when reading of data from a logical volume corresponding to the RAID group #21 is requested, the array controller 108 reads the divided data from a predetermined one of two HDDs to which the divided data has been mirrored. In the examples of FIG. 8 and FIG. 9, assume that the array controller 108 reads the divided data from the HDD 210a, 210c, and 210e.

In the example of FIG. 8, one hot spare HDD 210g is used as the temporary storage area of the data to be written in the HDD in which the rotation of a magnetic disk has been stopped. In this case, the power consumption may be reduced by stopping the rotations of the magnetic disks in two or more HDDs among the HDDs constituting the RAID group.

On the other hand, in the RAID group #21 managed by RAID 1+0, even if the operations of two of the HDDs 210a to 210f constituting the RAID group #21 are stopped, the data in the RAID group #21 will not be lost. However, up to two HDDs may be stopped from among one of the HDDs 210a and 210b, one of the HDDs 210c and 210d, and one of the HDDs 210e and 210f.

Then, in the example of FIG. 8, the array controller 108 stops the rotations of the magnetic disks in two of the HDDs 210a to 210f constituting the RAID group #21. As an example, the array controller 108 stops the rotation of the magnetic disk in each of the HDDs 210b, 210d, and 210f.

Moreover, the array controller 108 continues to receive an access to logical volumes each corresponding to the RAID group #21 in a state where the rotation of the magnetic disk in each of the HDDs 210b, 210d, and 210f is stopped. When data is written to the HDDs 210b, 210d, and 210f, the array controller 108 temporarily writes the data to the hot spare HDD 210f without writing the data in the HDDs 210b, 210d, and 210f. In the example of FIG. 9, pieces of mirrored data of the pieces of divided data Da to Df are written in the hot spare HDD 210g.

In this manner, the array controller 108 stops the rotation of the magnetic disk in each of the HDDs 210b, 210d, and 210f, and temporarily writes to the hot spare HDD 210g the data to be written in the HDDs 210b, 210d and 210f. Thus, the array controller 108 may make the data redundant with a lower power consumption.

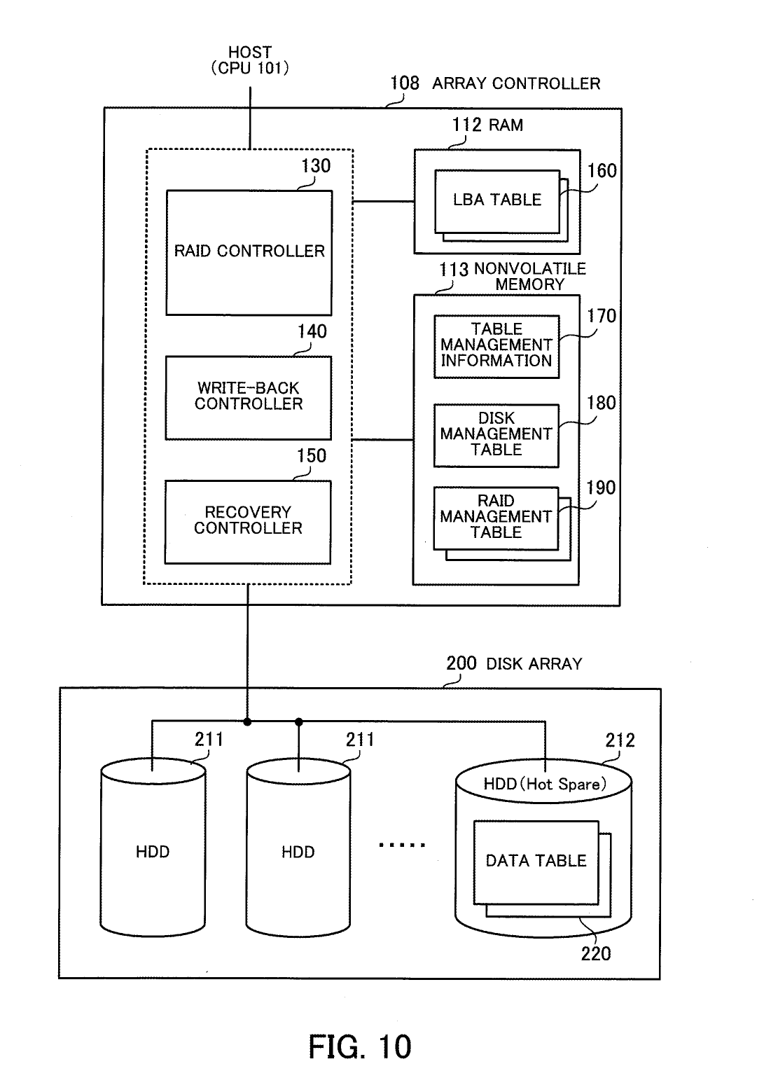

Next, FIG. 10 is a block diagram illustrating a configuration example of the processing functions of the array controller.

The array controller 108 includes a RAID controller 130, a write-back controller 140, and a recovery controller 150. The processing of each of the RAID controller 130, write-back controller 140, and recovery controller 150 is realized, for example, when the CPU 111 of the array controller 108 executes predetermined programs (e.g., the firmware 120 of FIG. 3).

Moreover, in processing performed by the array controller 108, an LBA (Logical Block Address) table 160, table management information 170, a disk management table 180, a RAID management table 190, and a data table 220 are used. The LBA table 160 is stored in the RAM 112 of the array controller 108, while the table management information 170, disk management table 180, and RAID management table 190 are stored in the nonvolatile memory 113 of the array controller 108. Moreover, the data table 220 includes a temporary storage area of the data to be written in an HDD, in which the rotation of the magnetic disk has been stopped, and is stored in the hot spare HDD.

Note that, in the description below, an HDD constituting any of RAID groups is designated by “HDD 211”, and a hot spare HDD is designated by “HDD 212”. Moreover, among the HDDs 211 constituting the RAID group, an HDD in which the magnetic disk is rotating is referred to as a “working HDD”, while an HDD in which the rotation of the magnetic disk has been stopped is referred to as a “stopped HDD”.

The RAID controller 130 performs the processing corresponding to the operation controller 11 and access controller 12 illustrated in FIG. 1. The RAID controller 130 receives from the host an access request to a logical volume corresponding to the RAID group, and performs the access processing to an HDD in accordance with the access request. Then, the RAID controller 130 stops the rotations of the magnetic disks in a plurality of HDDs 211 among the HDDs 211 constituting each RAID group to reduce the power consumption. Then, when data is written to a stopped HDD 211, the RAID controller 130 stores the data to be written in the HDD 211 to the data table 220 inside the hot spare HDD 212, thereby maintaining the data redundancy.

Here, the data table 220 is generated for each piece of data to be written in the stopped HDD 211. Moreover, an identification number of the lastly generated data table 220 is registered in the table management information 170, and is referred to by the RAID controller 130 in searching the data table 220.

Moreover, the setting information about an HDD 221, in which the rotation of the magnetic disk is to be stopped, and the setting information about the hot spare HDD 212 are registered in the disk management table 180 in advance, and the setting information about the RAID group is registered in the RAID management table 190 in advance. The disk management table 180 and the RAID management table 190 are referred to by the RAID controller 130.

Moreover, when data is written to the stopped HDD 211, the RAID controller 130 registers an original write destination address (i.e., the write destination address in the stopped HDD 211) in the LBA table 160.

The write-back controller 140 causes the stopped HDD 211 to start the rotation of the magnetic disk at a predetermined timing, and writes back to the HDD 211 the data that has been stored in the data table 220.

The recovery controller 150 executes the processing for recovery, for example, when any one of the HDDs 211 constituting the RAID group or the hot spare HDD 212 has abnormally stopped.

Note that at least part of the above-described processing of the RAID controller 130, write-back controller 140, and recovery controller 150 may be implemented when the CPU 101 of the information processing apparatus 100 executes predetermined programs.

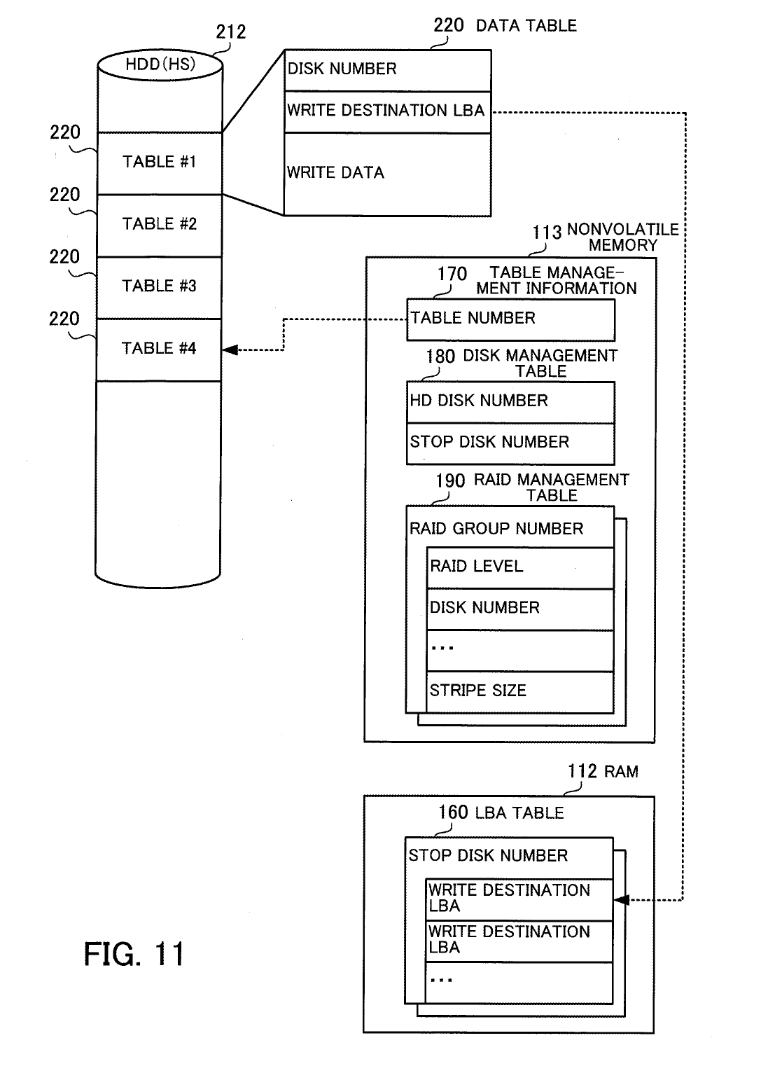

FIG. 11 illustrates an example of contents of information that are utilized in processing performed by the array controller.

The data table 220 is registered in the hot spare HDD 212 for each piece of data to be written in the stopped HDD 211 by the RAID controller 130. The “disk number”, “write destination LBA”, and “write data” are registered in each data table 220. The “write data” is the actual data to be written in the stopped HDD 211. The “disk number” is an identification number of the stopped HDD 211 which is the original write destination of the write data, and the “write destination LBA” indicates the original write destination address of the write data in the stopped HDD 211.

Note that, when data is written to the same address in the stopped HDD 211, the data table 220 already stored in the HDD 212 having the same disk number and write destination LBA registered therein will not be overwritten, but a new data table 220 is registered in the HDD 212.

The table management information 170 is the information that is utilized to search the data table 220 registered in the hot spare HDD 212. The table number for identifying the data table 220 lastly registered in the hot spare HDD 212 is registered in the table management information 170 by the RAID controller 130. In the example of FIG. 11, the data tables 220 having the table numbers of “1” to “4” are registered in the hot spare HDD 212, and in this case “4” is registered in the table management information 170 as the table number.

Note that, assume that the initial value of the table number registered in the table management information 170 is “0”. On the other hand, assume that the table number given to the first data table 220 registered in the hot spare HDD 212 is “1”. The case where the table number “0” is already registered in the table management information 170 indicates that the data table 220 is not registered in the hot spare HDD 212.

An “HS disk number” and a “stop disk number” are registered in the disk management table 180. The “HS disk number” is the identification number of the HDD 212 used as the hot spare. The “stop disk number” is the identification number of an HDD 211, in which the rotation of the magnetic disk is to be stopped, among the HDDs 211 constituting the RAID group.

The RAID management table 190 is generated for each RAID group. A “RAID group number”, a “RAID level”, a “disk number”, and a “stripe size” are registered in each RAID management table 190. The “RAID group number” is the identification number for identifying the corresponding RAID group. The “RAID level” indicates the RAID level set in the corresponding RAID group. The “disk number” is the identification number of the HDD 211 constituting the corresponding RAID group. Usually, a plurality of “disk numbers” is registered in one RAID management table 190. When the RAID level set in the corresponding RAID group is one of RAIDs 5, 6, and 1+0, the size for each HDD 211 in a stripe (i.e., the size of divided data) is registered in the “stripe size”.

The LBA table 160 is registered for each stopped HDD 211 by the RAID controller 130. The “stop disk number” and “write destination LBA” are registered in each LBA table 160. The “stop disk number” is the identification number of an HDD 211, in which the rotation of the magnetic disk is to be stopped, among the HDDs 211 constituting the RAID group. When data is written to the corresponding stopped HDD 211, the “write destination LBA” indicates the original write destination address in the stopped HDD 211. The “write destination address” registered in the LBA table 160 is always registered also in any one of the data tables 220. Moreover, at the maximum, as many “write destination LBAs” as the number of LBAs allocated to the stopped HDD 211 are registered in one LBA table 160.

Note that, as described above, when data is written to the same address in the same stopped HDD 211 multiple times, a plurality of data tables 220 having this HDD 211 and this address registered therein is registered. Therefore, the data table 220 including the same disk number and write destination LBA might be redundantly registered in the hot spare HDD 212.

The write-back controller 140 searches the data table 220 in the order from the end thereof and write-backs data. In this case, the write-back controller 140 deletes from the LBA table 160 an LBA corresponding to the data that has been written back. Thus, even in the case where the data table 220 including the same disk number and write destination LBA is redundantly registered, the write-back controller 140 may write back only the data included in the lastly registered data table 220.

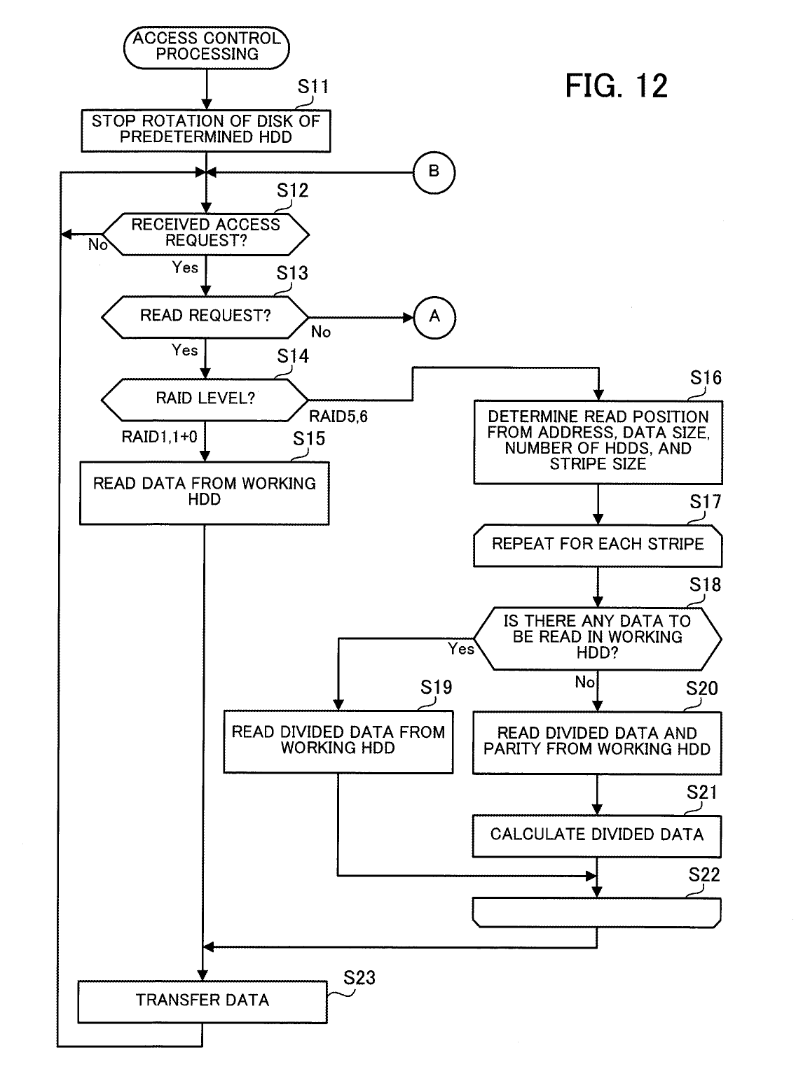

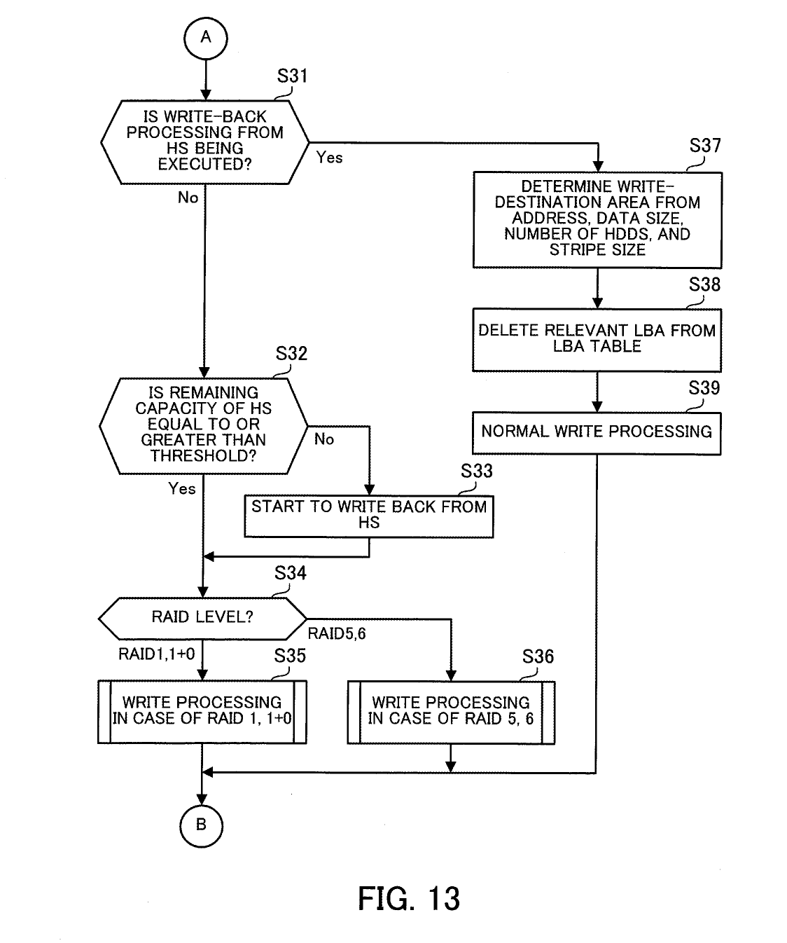

Next, the processing performed by the array controller 108 is described using a flow chart. First, FIG. 12 and FIG. 13 are flow charts illustrating an example of the access control processing performed by the RAID controller.

[Step S11] The RAID controller 130 transmits a command for instructing an HDD 211, which is indicated by the stop disk number registered in the disk management table 180, among the HDDs 211 constituting the RAID group, to stop the rotation of the magnetic disk. Accordingly, the rotation of the magnetic disk in the HDD 211 indicated by the stop disk number will stop.

[Step S12] The RAID controller 130 monitors an access request from the host for access to the logical volume corresponding to a RAID group set in the RAID management table 190, and executes processing of step S13 upon receipt of the access request.

[Step S13] When reading of data is requested from the host, processing of step S14 is executed, while when writing of data is requested, processing of step S31 in FIG. 13 is executed.

[Step S14] With reference to the RAID management table 190, the RAID controller 130 determines the RAID level of the RAID group from which the reading is requested. The RAID controller 130 executes processing of step S15 when the RAID level is RAID 1 or RAID 1+0, while when the RAID level is RAID 5 or RAID 6, it executes processing of step S16.

[Step S15] The RAID controller 130 reads from a working HDD 211 the data requested to be read.

As an example of the case of RAID 1, the RAID controller 130 reads the data from a working HDD 210a among the HDDs 210a and 210b constituting the RAID group #01 of FIG. 4. Moreover, as an example of the case of RAID 1+0, the RAID controller 130 reads the divided data from at least one of the working HDDs 210a, 210c, and 210e among the HDDs 210a to 210f constituting the RAID group #21 of FIG. 8.

[Step S16] the RAID controller 130 determines in which HDD 211 among the HDDs 211 constituting the RAID group and at which position of the HDD 211 each divided data constituting the data requested to be read is stored, based on the read address on a logical volume and data size specified by the host and the number of disk numbers (i.e., the number of the HDDs 211 constituting the RAID group) registered in the RAID management table 190 and the stripe size. The read position determined here is consistently the original read position in the HDD 211 constituting the RAID group, and does not include the temporary storage area in the hot spare HDD 212.

[Step S17] Processing from the step S17 to the step S22 which is the loop end is repeated for each stripe to be read. For example, when the area to be read spans a plurality of stripes, processing from step S17 to step S22 is repeated multiple times.

[Step S18] The RAID controller 130 determines whether all pieces of the divided data to be read included in the stripe to be processed are stored in a working HDD 211 among the HDDs 211 constituting the RAID group from which the reading is requested. The RAID controller 130 executes processing of step S19 when all pieces of the divided data to be read are stored in the working HDD 211. On the other hand, the RAID controller 130 executes processing of step S20 when the divided data to be read includes any divided data not stored in the working HDD 211 (i.e., when there is any divided data whose original storing location is in the stopped HDD 211).

[Step S19] The RAID controller 130 reads from the working HDD 211 the divided data to be read.

For example, when a stripe including the pieces of divided data Da and Db and parity Pab in FIG. 5 is the stripe to be processed and the pieces of divided data Da and Db are the divided data to be read, the pieces of divided data Da and Db are stored in the working HDDs 210c and 210d, respectively. In this case, in step S18, it is determined as “Yes”, and in step S19, the pieces of divided data Da and Db are read from the working HDDs 210c and 210d, respectively.

[Step S20] The RAID controller 130 reads the divided data and parity included in the stripe to be processed, from the working HDD 211 among the HDDs 211 constituting the RAID group from which the reading is requested.

[Step S21] The RAID controller 130 calculates the divided data to be read from the stopped HDD 211, based on the divided data and parity read in step S20.

For example, in a case where a stripe including the pieces of divided data Dc and Dd and parity Pcd in FIG. 5 are to be processed and the pieces of divided data Dc and Dd are to be read, the divided data Dd is not stored in the working HDDs 210c and 210d. In this case, in step S18, it is determined as “No”, and in step S19, the divided data Dc and parity Pcd are read from the working HDDs 210c and 210d, respectively, and in step S20, the divided data Dd is calculated.

[Step S22] Once processing from step S17 to step S22 is executed with respect to all the stripes to be read, then processing of step S23 is executed.

[Step S23] The RAID controller 130 transfers to the host the data requested to be read. Thereafter, the flow returns to step S12, where the access request is monitored.

In the above-described read control processing illustrated in steps S14 to S23, the magnetic disk in the stopped HDD 211 will not be rotated again and the read processing is performed only from the working HDD 211. Thus, there is no need to wait until the stopped HDD 211 becomes accessible, and a decrease in the response speed in response to the read request from the host may be suppressed.

Note that, in steps S20 and S21, the RAID controller 130 may read from the hot spare HDD 212 the divided data that are unable to be read from the working HDD 211. However, in this case, the RAID controller 130 needs to search the data table 220 having the divided data registered therein from the hot spare HDD 212, and therefore the response time in response to the read request from the host might increase due to the search processing. The RAID controller 130 may more stably suppress a delay of the response time in response to the read request by calculating the divided data by using the parity instead of searching the data table 220.

Next, the processing when writing of data is requested is described using FIG. 13.

[Step S31] The RAID controller 130 determines whether the write-back processing of data from the hot spare (HS) HDD 212 performed by the write-back controller 140 is being executed. The RAID controller 130 executes processing of step S37 when the write-back processing is being executed, while when the write-back processing is not being executed, it executes processing of step S32.

[Step S32] The RAID controller 130 determines whether the remaining capacity of the hot spare HDD 212 is equal to or greater than a predetermined threshold. The RAID controller 130 executes processing of step S34 when the remaining capacity is equal to or greater than the threshold, while when the remaining capacity is less than the threshold, it executes processing of step S33.

[Step S33] The RAID controller 130 causes the write-back controller 140 to start the write-back processing of the data that is temporarily stored in the hot spare HDD 212. Thus, the write-back processing by the write-back controller 140 is executed in parallel with the control processing performed by the RAID controller 130.

Note that, in the embodiment, assume that the threshold used in step S32 is set to a value equal to or greater than the size of the data table 220 including the maximum data amount that is written in one write request. Thus, the RAID controller 130 may complete the write processing of step S35 or step S36 after instructing to start to write back in step S33 and before the stopped HDD 211 becomes writable, and accordingly the RAID controller 130 may suppress a decrease in the write response speed.

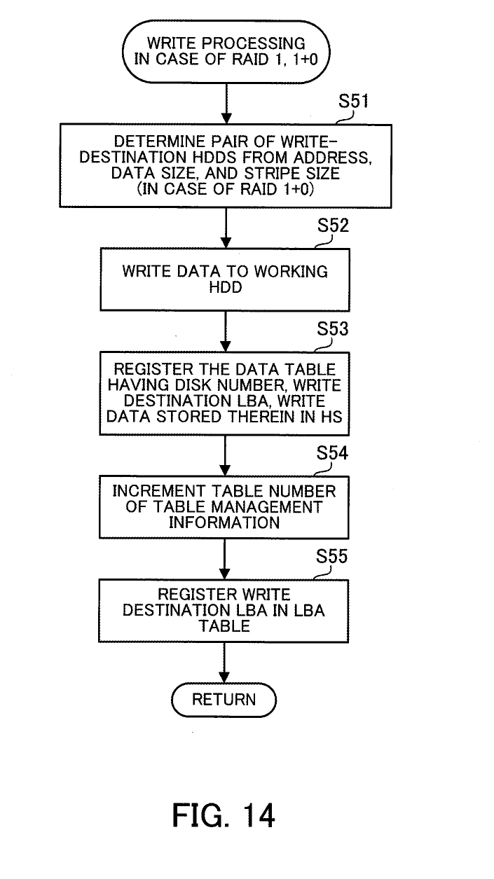

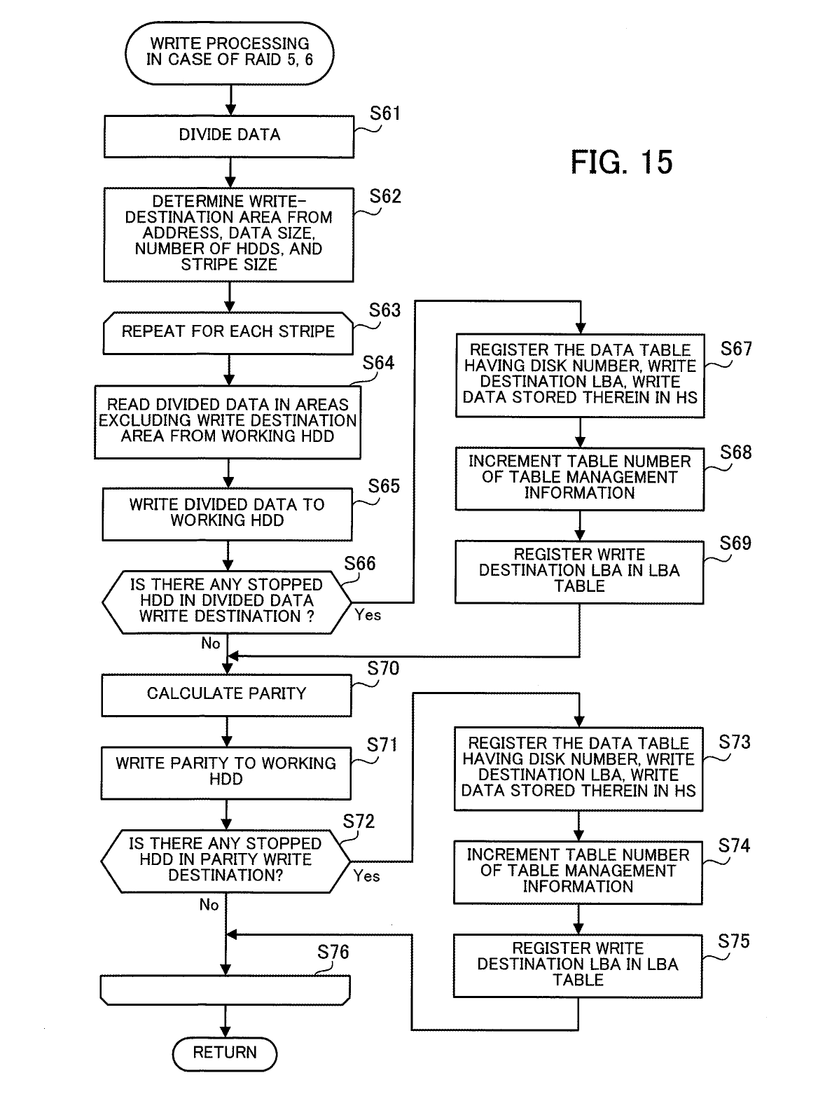

In contrast, when the threshold used in step S32 is set to a smaller value, it is not assured whether all pieces of data to be written in the stopped HDD 211 are writable to the hot spare HDD 212. In this case, the writing may be completed by changing the processing such that the flow proceeds to step S37 after step S33. However, processing of the step S37 and subsequent steps is not executed until the rotation of the magnetic disk in the stopped HDD 211 is started and this HDD 211 becomes writable.

[Step S34] With reference to the RAID management table 190, the RAID controller 130 determines the RAID level of a RAID group to which the writing is requested. The RAID controller 130 executes processing of step S35 when the RAID level is RAID 1 or RAID 1+0, while when the RAID level is RAID 5 or RAID 6, it executes processing of step S36.

[Step S35] The RAID controller 130 executes the write processing in the case of RAID 1 or RAID 1+0. The detail of this processing will be described in FIG. 14.

[Step S36] The RAID controller 130 executes the write processing in the case of RAID 5 or RAID 6. The detail of this processing will be described in FIG. 15.

After step S35 or step S36 is executed, the flow returns to step S12, where the access request is monitored.

[Step S37] The RAID controller 130 determines in which HDD 211 among the HDDs 211 constituting the RAID group and at which position of the HDD 211 each divided data constituting the data requested to be written is to be stored, based on the write address on a logical volume and data size specified by the host and the number of disk numbers (i.e., the number of the HDDs 211 constituting the RAID group) and stripe size registered in the RAID management table 190. The write destination area determined here is consistently the original read position in the HDD 211 constituting the RAID group, and does not include the temporary storage area in the hot spare HDD 212.

[Step S38] While the write-back controller 140 is executing write-back, all the HDDs 211 constituting the RAID group, to which the writing is requested, are in a working state. In this case, the RAID controller 130 writes the data to the HDD 211 constituting the RAID group without writing the data to the hot spare HDD 212.

In step S38, the RAID controller 130 first deletes, when the LBA included in the write destination area determined in step S37 is already registered in the LBA table 160 corresponding to the write destination RAID group, this LBA from the LBA table 160. Thus, the RAID controller 140 prevents, when the old data requested to be written to the same write destination area is already written in the temporary storage area of the hot spare HDD 212, this old data from being subsequently written back to the working HDD 211. In other words, when the old data requested to be written to the same write destination area is already written in the temporary storage area of the hot spare HDD 212, this old data is discarded.

For example, in FIG. 11, assume that the LBA included in the write destination area determined in step S37 is already registered in the data table 220 of the table number “1”. This LBA is referred to as “LBA#1”. Then in step S38, the RAID controller 130 deletes LBA#1, which is already registered in the data table 220 of the table number “1” as the write destination LBA, from the LBA table 160.

As described later, the write-back controller 140 writes back data only to the LBA registered in the LBA table 160. Accordingly, LBA#1 is deleted from the LBA table 160. Therefore, the write-back controller 140 will not write back the write data that is included in the data table 220 including LBA#1, although the data table 220 is already registered in the hot spare HDD 212. Thus, the old data corresponding to the relevant LBA is prevented from being overwritten after the latest data is written in the relevant LBA in the next step S39.

Note that, in step S38, the RAID controller 130 may determine in a short time whether there is any old data requested to be written in the same write destination area, by referring to the LBA table 160 recorded on the RAM 112 of the array controller 108 without searching the data table 220. Thus, the response speed in response to the write request from the host may be improved.

[Step S39] Because all the HDDs 211 constituting the write destination RAID group are working, the RAID controller 140 executes the normal write processing in accordance with the RAID level, i.e., the write processing with respect to the writing area determined in step S37. Thereafter, the flow returns to step S12, where the access request is monitored.

As illustrated in the above-described steps S37 to S39, while the write-back controller 140 is executing write back, the RAID controller 130 writes data to the HDD 211 constituting the RAID group without writing the data to the hot spare HDD 212. In this case, the RAID controller 140 may simplify the write procedure by, for example, executing only delete processing of the write destination LBA in step S38 as table update processing. Therefore, the RAID controller 130 may complete the writing of data in a short time as compared with the write processing in step S35 or step S36 described later.

FIG. 14 is the flow chart illustrating an example of the write processing in the case of RAID 1 or RAID 1+0. The processing of FIG. 14 corresponds to processing of step S35 in FIG. 13.

[Step S51] This step S51 is executed only when the RAID level of the RAID group, to which the writing is requested, is RAID 1+0. The RAID controller 130 determines a pair of write destination HDDs 211 from the HDDs 211 constituting the RAID group to which the writing is requested, based on the write address on a logical volume and data size specified by the host and the stripe size registered in the RAID management table 190.

The pair of HDDs 211 as referred to here is a pair of HDDs 211 to which the divided data is mirrored. For example, if writing of data to a logical volume corresponding to the RAID group #21 illustrated in FIG. 8 is requested and the volume of the divided data generated from the data requested to be written is equal to or greater than the size of one stripe, then a pair of HDD 210a and HDD 210b, a pair of HDD 210c and HDD 210d, and a pair of HDD 210e and HDD 210f are determined as the pairs of write destination HDDs.

[Step S52] The RAID controller 130 writes the data to a working HDD 211 among the HDDs 211 constituting the RAID group to which the writing is requested. Note that, when the RAID level is RAID 1+0, the RAID controller 130 writes the divided data to the working HDD 211 among the pairs of HDDs 211 determined in step S51. According to this step S52, the data is written only to one of the pair of HDDs 211 to which the data is mirrored.

[Step S53] The RAID controller 130 performs the processing to write to the hot spare HDD 212 the data to be written in the stopped HDD 211.

Specifically, the RAID controller 130 creates the data table 220 for each combination of the disk number indicative of the stopped HDD 211, which is the original write destination, and a data write destination LBA in this HDD 211. The RAID controller 130 registers the corresponding disk number and write destination LBA and the write data in each data table 220, and registers each data table 220 in the hot spare HDD 212 in the order of writing data.

[Step S54] The RAID controller 130 increments the table number of the table management information 170 by the number of data tables 220 that is registered in step S53. Note that the initial value of the table number in the initial state where no data table 220 is registered is “0”.

[Step S55] The RAID controller 130 identifies the LBA tables 160 each corresponding to the stopped HDD 211 (i.e., the HDD 211 indicated by the disk number that is registered in the data table 220 in step S53) which is the original write destination of the data. The RAID controller 130 registers the write destination LBA, which is registered in the data table 220 in step S53, in each identified LBA table 160. Thus, the write destination LBA in the original HDD 211 for each piece of data, which is temporarily written in the hot spare HDD 212, is registered in the LBA table 160.

Note that, in this step S55, when the same LBA is already registered in the identified LBA table 160, the RAID controller 130 skips the registration of this LBA. That is, the same LBA will not be redundantly registered in each LBA table 160.

FIG. 15 is the flow chart illustrating an example of the write processing in the case of RAID 5 or RAID 6. The processing of FIG. 15 corresponds to the processing of step S36 in FIG. 13.

[Step S61] The RAID controller 130 divides the write data, which is received from the host, for each stripe size registered in the RAID management table 190 to generate divided data.

[Step S62] The RAID controller 130 determines in which HDD 211 among the HDDs 211 constituting the RAID group and at which position of the HDD 211 each divided data constituting the data requested to be written is to be stored, based on the write address on a logical volume and data size specified by the host and the number of disk numbers (i.e., the number of the HDDs 211 constituting the RAID group) registered in the RAID management table 190 and the stripe size. The write destination area determined here is consistently the original read position in the HDD 211 constituting the RAID group, and does not include the temporary storage area in the hot spare HDD 212.

[Step S63] The processing from step S63 to the step S76 which is the loop end is repeated for each stripe included in the determined write destination area. For example, when the write destination area spans a plurality of stripes, the processing from step S63 to step S76 is repeated multiple times.

[Step S64] The RAID controller 130 reads from the working HDD 211 the divided data not included in the write destination area, which is determined in step S61, among the pieces of divided data included in the stripe to be processed. For example, when a stripe including the pieces of divided data Da and Db and parity Pab in FIG. 5 is the stripe to be processed and the divided data Db and parity Pab are included in the write destination area, the RAID controller 130 reads from the HDD 210c the divided data Da not included in the write destination area. The read divided data Da is used to calculate the latest parity Pab.

[Step S65] The RAID controller 130 writes to the corresponding HDD 211 the divided data of the working write destination HDD 211 among the pieces of divided data generated in step S61 included in the stripe to be processed.

[Step S66] The RAID controller 130 determines whether there is any stopped HDD 211 among the HDDs 211 serving as the write destination of the divided data included in the stripe to be processed. The RAID controller 130 executes processing of step S67 when there is any stopped HDD 211, while when there is no stopped HDD 211, it executes processing of step S70.

[Step S67] The RAID controller 130 performs the processing to write to the hot spare HDD 212 the divided data to be written in the stopped HDD 211.

Specifically, the RAID controller 130 creates the data table 220 having the disk number indicative of the stopped HDD 211 that is the original write destination of the divided data, the data write destination LBA in the HDD 211, and the divided data stored therein. The RAID controller 130 registers the created data table 220 in the hot spare HDD 212.

Note that, in the case of RAID 6, two HDDs 211 might be in a stopped state and therefore in step S67, up to two data tables 220 are registered in the hot spare HDD 212.

[Step S68] The RAID controller 130 increments the table number of the table management information 170 by the number of data tables 220 registered in step S67.

[Step S69] The RAID controller 130 identifies the LBA tables 160 each corresponding to the stopped HDD 211 (i.e., the HDD 211 indicated by the disk number that is registered in the data table 220 in step S67) which is the original write destination of the divided data. The RAID controller 130 registers in each identified LBA table 160 the write destination LBA that is registered in the data table 220 in step S67. Thus, the write destination LBA in the original HDD 211 of each divided data, which is temporarily written in the hot spare HDD 212, is registered in the LBA table 160.

Note that, in this step S69, as with step S55 in FIG. 15, the same LBA will not be redundantly registered in each LBA table 160.

[Step S70] The RAID controller 130 calculates the parity. In the case of RAID 6, the P-parity and Q-parity are calculated.

[Step S71] The RAID controller 130 writes to the corresponding HDD 211 the parity of a working write destination HDD 211 among the parities calculated in step S70.

[Step S72] The RAID controller 130 determines whether there is any stopped HDD 211 among the HDDs 211 serving as the write destination of the parity calculated in step S70. The RAID controller 130 executes processing of step S73 when there is any stopped HDD 211. On the other hand, when there is no stopped HDD 211, the flow proceeds to step S76.

[Step S73] The RAID controller 130 performs the processing to write to the hot spare HDD 212 the parity to be written in the stopped HDD 211.

Specifically, the RAID controller 130 creates the data table 220 having the disk number indicative of the stopped HDD 211 that is the original write destination of the parity, the data write destination LBA in the HDD 211, and the parity stored therein. The RAID controller 130 registers the created data table 220 in the hot spare HDD 212.

Note that, in the case of RAID 6, two HDDs 211 might be in a stopped state and therefore in step S73, up to two data tables 220 are registered in the hot spare HDD 212.

[Step S74] The RAID controller 130 increments the table number of the table management information 170 by the number of data tables 220 registered in step S73.

[Step S75] The RAID controller 130 identifies the LBA tables 160 each corresponding to the stopped HDD 211 (i.e., the HDD 211 indicated by the disk number that is registered in the data table 220 in step S73) which is the original write destination of the parity. The RAID controller 130 registers in each identified LBA table 160 the write destination LBA that is registered in the data table 220 in step S73. Thus, the write destination LBA in the original HDD 211 of each parity temporarily written in the hot spare HDD 212 is registered in the LBA table 160.

Note that, in this step S75, as with step S55 in FIG. 14, the same LBA will not be redundantly registered in each LBA table 160.

[Step S76] The write processing is completed when processing from step S63 to step S76 has been executed for all the stripes included in the write destination area.

According to the access control processing described in FIG. 12 to FIG. 15, the RAID controller 130 may make data redundant while reducing power consumption.

Moreover, the temporary storage area of the data to be written in the stopped HDD 211 is set to the hot spare HDD 212 that is a nonvolatile storage region, so that, for example, even when the storage system is restarted after the storage system abnormally stopped, the data in the temporary storage area is retained without being deleted. Therefore, the RAID controller 130 may continue the operation of the RAID group while maintaining the data redundancy. Note that the processing at the time of restart is described in detail later.

At the same time, for example, as compared with the case where the temporary storage area is set to the RAM, a large capacity of storage area may be secured as the temporary storage area at a low cost.

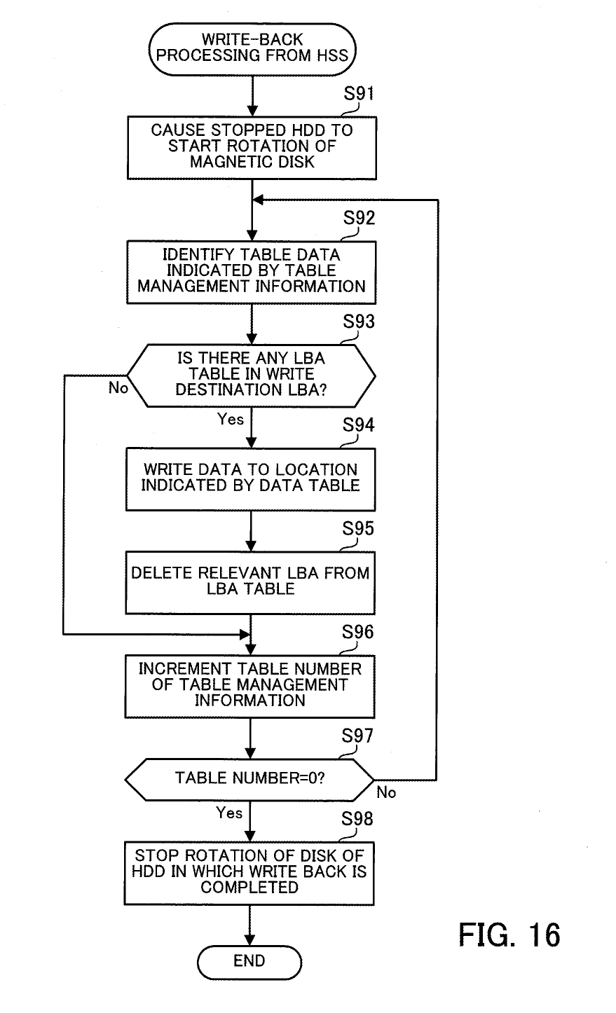

Next, FIG. 16 is the flow chart illustrating an example of the write-back processing from a hot spare HDD. The process of FIG. 16 is executed, for example, when the RAID controller 130 requests to start the write back in step S33 in FIG. 13. Alternatively, the process of FIG. 16 may be executed at any timing, for example, outside the working hours.

[Step S91] The write-back controller 140 transmits a command for instructing the stopped HDD 211 indicated by the stop disk number registered in the disk management table 180 to rotate the magnetic disk. Thus, the rotation of the magnetic disk is started in each stopped HDD 211.

[Step S92] The write-back controller 140 identifies the data table 220 indicated by the table number registered in the table management information 170.

[Step S93] The write-back controller 140 reads the disk number from the data table 220 identified in step S92, and refers to the LBA table 160 corresponding to the read disk number. The write-back controller 140 determines whether the write destination LBA registered in the data table 220 identified in step S92 is already registered in the referred LBA table 160.

The write-back controller 140 executes the write-back processing of step S94 when the write destination LBA is already registered. On the other hand, the case where the write destination LBA is not registered indicates that the latest data about this LBA is already registered in the original HDD 211. In this case, the write-back controller 140 executes processing of step S96 without writing back the write data registered in the data table 220 identified in step S92.

Note that, the latter case includes a case where the latest data registered in the hot spare HDD 212 is already written back to the original HDD 211, and a case where during the write-back processing, new data for the relevant LBA was transmitted from the host and written in the original HDD 211 (the case where steps S37 to S39 in FIG. 13 were executed).

[Step S94] The write-back controller 140 transfers and writes the latest data registered in the data table 220 identified in step S92 to the location indicated by the disk number and write destination LBA registered in the data table 220.

[Step S95] The write-back controller 140 deletes the write destination LBA registered in the data table 220 identified in step S92, from the LBA table 160 that was referred to in step S93.

[Step S96] The write-back controller 140 decrements the table number registered in the table management information 170 by “1”.

[Step S97] When the table number after decrement is equal to or greater than “1”, the write-back controller 140 returns to Step S92 and executes the processing of step S92 and subsequent steps with reference to the data table 220 that had been registered one time earlier. By repeating the processing of steps S92 to S97, the data tables 220 registered in the hot spare HDD 212 are referred to in descending order (i.e., in the order opposite to the order of registration), and only the latest data corresponding to the same LBA of the same HDD is written back to the original HDD 211 that has transitioned to a working state. Then, the write-back controller 140 executes processing of step S98 when the table number after decrement in step S96 becomes “0”.

[Step S98] The write-back controller 140 transmits a command for instructing the HDD 211, in which the write back has been completed, to stop the rotation of the magnetic disk. Thus, each HDD 211, which transitioned to the working state in step S91, transitions to the stopped state again.

According to the above-described process of FIG. 16, the write-back controller 140 may write back to the HDD 211, the operation of which has been stopped and in which the data is to be originally written, the data temporarily written in the hot spare HDD 212.

Moreover, as described above, even when data is written to the same LBA of the same HDD multiple times, the RAID controller 130 of the embodiment creates a new data table 220 each time and adds the same to the hot spare HDD 212. Thus, upon receipt of a request to write data from the host, the RAID controller 130 does not need to search the host data table 220 having the old data about the same LBA of the same HDD registered therein. Thus, the response time in response to a write request from the host may be reduced.

On the other hand, the write-back controller 140 may, even when data is written to the same LBA of the same HDD multiple times, write back only the latest data by utilizing the LBA table 160. Moreover, the LBA table 160 is stored in the RAM 112, not in the nonvolatile memory 113, so that the write-back controller 140 may read and update the LBA table 160 at high speed and as a result may reduce the time needed for the write-back processing.

Next, the processing in turning on the power supply of the array controller 108 in a stopped state to start the array controller 108 is described. This start processing is executed, for example, when the array controller 108 is started again after normally stopping the array controller 108 by turning off the power supply of the array controller 108. Alternatively, this start processing may be executed when the storage system restarts after the storage system has stopped due to a certain failure.

Hereinafter, as the start processing of the array controller 108, two examples are illustrated.

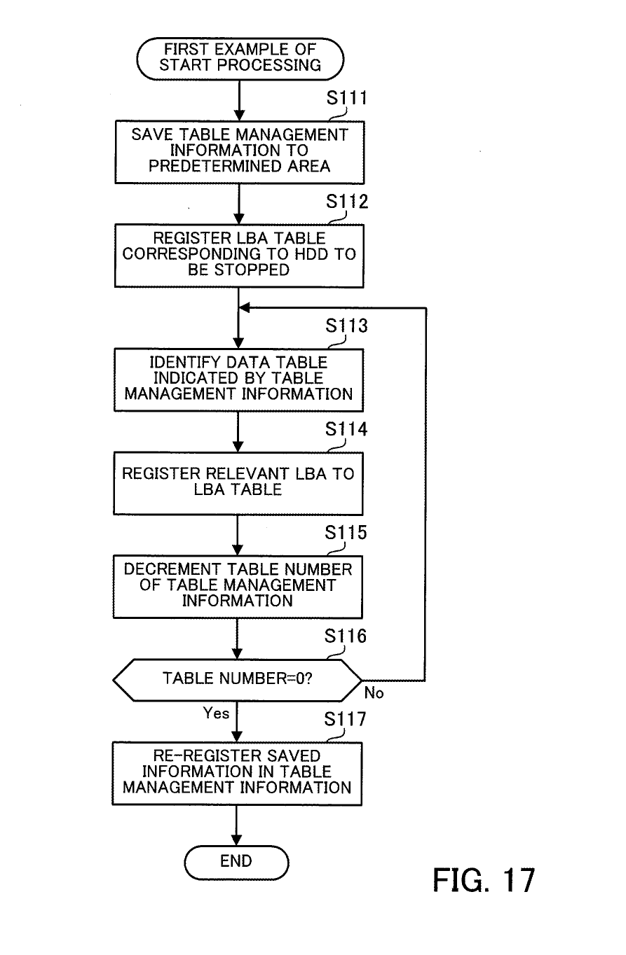

First, FIG. 17 is the flow chart illustrating a first example of the start processing of the array controller.

Because the LBA table 160 is stored in the RAM 112, the content of the LBA table 160 will disappear once the power supply of the array controller 108 is turned off. In the first example of the start processing illustrated in FIG. 17, the disappeared content of the LBA table 160 is reconstructed to enable continuous use of the data temporarily written in the hot spare HDD 212.

[Step S111] The recovery controller 150 saves the table number registered in the table management information 170 inside the nonvolatile memory 113 to a predetermined storage area (e.g., another area on the nonvolatile memory 113).

[Step S112] The recovery controller 150 registers in the RAM 112 the LBA tables 160 each corresponding to the HDD 211 indicated by the stop disk number registered in the disk management table 180. Note that, in the stage of step S112, nothing is registered in each registered LBA table 160.

In the following steps S112 to S116, the table management information 170 is used for reconstruction of the LBA table 160.

[Step S113] The recovery controller 150 identifies the data table 220 indicated by the table number registered in the table management information 170.

[Step S114] The recovery controller 150 reads the disk number from the data table 220 identified in step S113, and refers to the LBA table 160 corresponding to the read disk number. The recovery controller 150 registers in the referred LBA table 160 the write destination LBA registered in the data table 220 identified in step S113. Note that, when the write destination LBA read from the data table 220 is already registered in the LBA table 160, the recovery controller 150 skips the registration of the write destination LBA.

[Step S115] The recovery controller 150 decrements the table number registered in the table management information 170 by “1”.

[Step S116] When the table number after decrement is equal to or greater than “1”, the recovery controller 150 returns to Step S113 and executes the processing of step S113 and subsequent steps with reference to the data table 220 that had been registered one time earlier. By repeating the processing of steps S113 to S116, the data tables 220 registered in the hot spare HDD 212 are referred to in descending order and the LBA table 160 is reconstructed based on the referred data table 220. Then, the recovery controller 150 executes processing of step S117 when the table number after decrement in step S115 becomes “0”.

[Step S117] The recovery controller 150 reregisters in the table management information 170 the table number that is saved to the predetermined storage area in step S111.

According to the first example of the start processing described above, the LBA table 160 and table management information 170 may be restored to the state immediately before the power supply of the array controller 108 is turned off. Thus, the array controller 108 becomes ready to perform the access control processing illustrated in FIG. 12 and FIG. 13 and the write-back processing illustrated in FIG. 16.

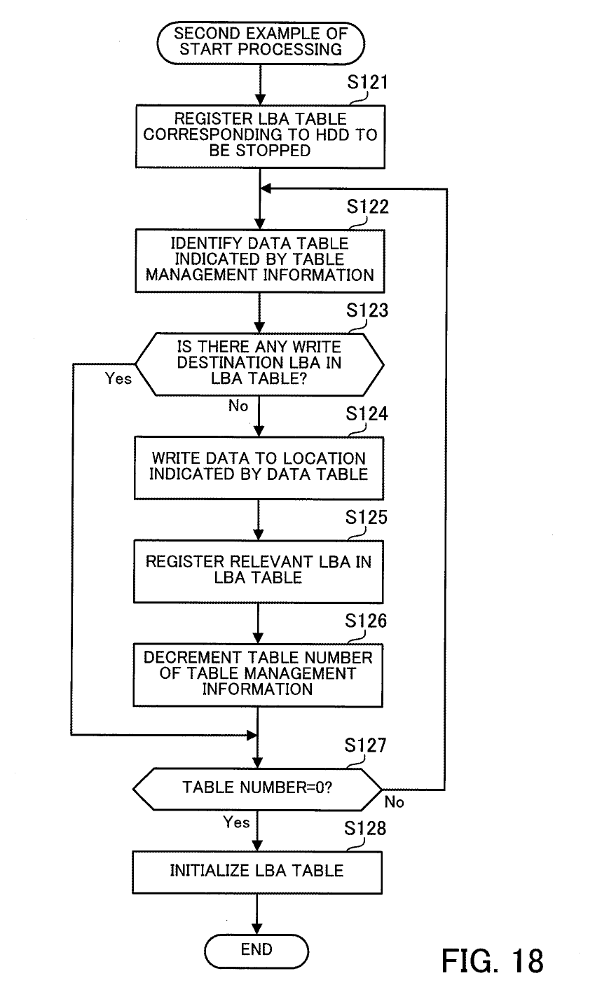

Moreover, in the first example of the start processing described above, like the second example of the start processing illustrated in FIG. 18, the time needed for the start processing is reduced by the amount that the write back of data from the hot spare HDD 212 to the original HDD 211 is not executed.

FIG. 18 is the flow chart illustrating a second example of the start processing of the array controller.

In the second example of the start processing illustrated in FIG. 18, using the information remaining in the nonvolatile memory 113, the data temporarily written in the hot spare HDD 212 is written back to the original HDD 211 to initialize the information that is utilized in the temporary storage area and for the management therefor. In this second example of the start processing, the array controller 108 enables the initialization of the temporary storage area by using the LBA table 160, whose memory content has been lost by turning off the power supply, for a purpose different from the original purpose of being used in writing back.

[Step S121] The recovery controller 150 registers in the RAM 112 the LBA tables 160 each corresponding to the HDD 211 indicated by the stop disk number registered in the disk management table 180. Note that, in the stage of step S121, nothing is registered in each registered LBA table 160.

[Step S122] The recovery controller 150 identifies the data table 220 indicated by the table number registered in the table management information 170.

[Step S123] The recovery controller 150 reads the disk number from the data table 220 identified in step S122, and refers to the LBA table 160 corresponding to the read disk number. The recovery controller 150 determines whether the write destination LBA registered in the data table 220 identified in step S122 is already registered in the referred LBA table 160.

When the write destination LBA is not registered, the recovery controller 150 executes processing of step S124 to cause the write-back controller 140 to execute the write-back processing. On the other hand, when the write destination LBA is already registered, the recovery controller 150 executes processing of step S127 without causing the write-back controller 140 to execute the write-back processing.

That is, in the second example of the start processing of FIG. 18, the case where the write destination LBA is already registered in the LBA table 160 indicates that the latest data is already written back to the area of the HDD 211 corresponding to the write destination LBA and therefore there is no need to write back.

[Step S124] The recovery controller 150 notifies the write-back controller 140 of the table number of the data table 220 identified in step S122, and instructs the write-back controller 140 to write back. The write-back controller 140 transfers and writes the latest data registered in the data table 220, to the location indicated by the disk number and write destination LBA that are registered in the data table 220 indicated by the table number notified.

[Step S125] The recovery controller 150 registers the write destination LBA registered in the data table 220 identified in step S122, in the LBA table 160 that was referred to in step S123.

[Step S126] The recovery controller 150 decrements the table number registered in the table management information 170 by “1”.

[Step S127] When the table number after decrement is equal to or greater than “1”, the recovery controller 150 returns to step S122 and executes the processing of step S122 and subsequent steps with reference to the data table 220 that had been registered one time earlier. By repeating the processing of steps S122 to S127, the data tables 220 registered in the hot spare HDD 212 are referred to in descending order, and only the latest data corresponding to the same LBA of the same HDD is written back to the HDD 211 that is the original write destination.

Then, the recovery controller 150 executes processing of step S128 when the table number after the decrement in the step S127 becomes “0”. In this state, the data table 220 registered in the HDD 212 is nullified because the initial value “0” is already registered in the table management information 170.

[Step S128] The recovery controller 150 deletes the write destination LBA registered in all the LBA tables 160 to initialize each LBA table 160.

The second example of the start processing is executed as described above, so that the array controller 108 is ready to execute the access control processing illustrated in FIG. 12 and FIG. 13.

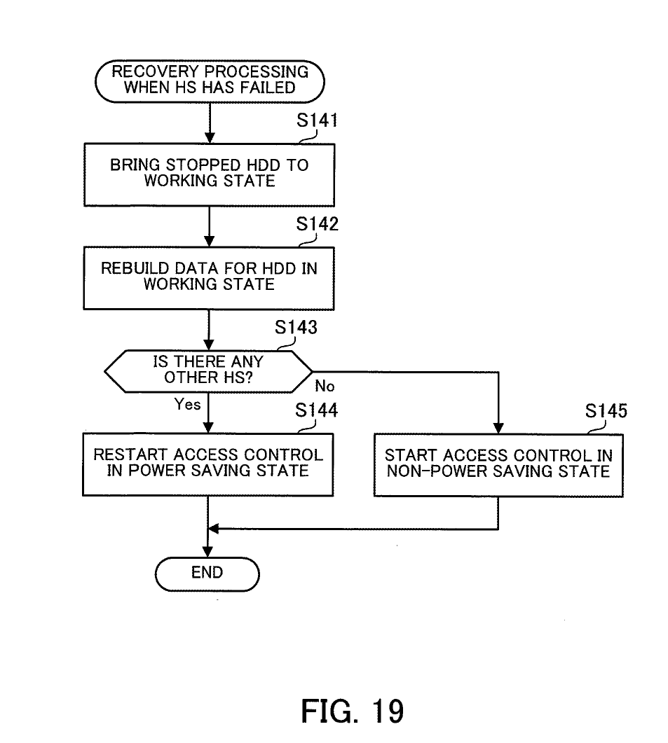

Next, the recovery processing is described in the case where either one of the HDDs has failed while the access control processing by the RAID controller 130 is being executed. First, FIG. 19 is the flow chart illustrating an example of the recovery processing when a hot spare HDD has failed.

[Step S141] The recovery controller 150 transmits a command for instructing the stopped HDD 211 indicated by the stop disk number registered in the disk management table 180 to rotate the magnetic disk. Thus, the rotation of the magnetic disk is started in each stopped HDD 211, and each stopped HDD 211 transitions to a working state.

[Step S142] The recovery controller 150 rebuilds, based on the data read from other HDDs 211 excluding an HDD 211 that was set to a working state in step S141, among the HDDs 211 constituting the RAID group, the data to be written in the HDD 211 having transitioned to a working state. Then, the recovery controller 150 writes the rebuilt data to the HDD 211 having transitioned to a working state.

For example, in the RAID group #01 illustrated in FIG. 4, the HDD 210b transitions from a stopped state to a working state, and the data stored in the HDD 210a is copied to the HDD 210b.

Moreover, in the RAID group #02 illustrated in FIG. 4, the HDD 210e transitions from a stopped state to a working state. Then, for each area of the same stripe number in the HDDs 210c to 210e, the data to be written in the HDD 210e is calculated based on the data read from the HDDs 210c and 210d, and the calculated data is written in the HDD 210e. For example, in FIG. 5, the parity Pab is calculated based on the pieces of divided data Da and Db, and the parity Pab is written in the HDD 210e. Moreover, the divided data Dd is calculated based on the divided data Dc and the parity Pcd, and the divided data Dd is written in the HDD 210e.

Moreover, in the RAID group #11 illustrated in FIG. 6, the HDDs 210d and 210e transition from a stopped state to a working state. Then, for each area of the same stripe number in the HDDs 210a to 210e, the data to be written in the HDD 210d and HDD 210e is calculated based on the data read from the HDDs 210a to 210c, and the calculated data is written in the HDD 210d and HDD 210e.

For example, in FIG. 7, the P-parity Pabc and Q-parity Qabc are calculated based on the pieces of divided data Da to Dc, the P-parity Pabc is written in the HDD 210d, and the Q-parity Qabc is written in the HDD 210e, respectively. Moreover, the Q-parity Qdef and divided data Df are calculated based on the pieces of divided data Dd and De and the P-parity Pdef, the Q-parity Qdef is written in the HDD 210d, and the divided data Df is written in the HDD 210e, respectively.

Moreover, in the RAID group #21 illustrated in FIG. 8, the HDDs 210b, 210d, and 210f transition from a stopped state to a working state. Then, the data of the HDD 210a is copied to the HDD 210b, the data of the HDD 210c is copied to the HDD 210d, and the data of the HDD 210e is copied to the HDD 210f, respectively.

[Step 143] The recovery controller 150 determines whether there is any other HDD usable as the hot spare. When there is any HDD usable as the hot spare, the recovery controller 150 registers the disk number of this HDD in the disk management table 180 as the HS disk number, and incorporates this HDD as the hot spare HDD 212. Then, the recovery controller 150 executes processing of step S144. On the other hand, the recovery controller 150 executes processing of step S145 when there is no HDD usable as a hot spare.

[Step S144] The recovery controller 150 causes the RAID controller 130 to resume the access control in a power saving state. The access control in the power saving state is, as illustrated in FIG. 12 and FIG. 13, the access control for bringing a predetermined HDD constituting the RAID group to a stopped state, the control being executed using the hot spare HDD 212 as a temporal writing area.

[Step S145] The recovery controller 150 causes the RAID controller 130 to start the access control in a non-power saving state. The access control in the non-power saving state is the processing to bring all the HDDs constituting each RAID group to a working state and to perform the access control corresponding to the RAID level.

According to the above-described process of FIG. 19, the array controller 108 may resume the access control in accordance with an access request from the host for access to the logical volume corresponding to each RAID group even when the hot spare HDD 212 that had been used as a temporal writing area has failed.

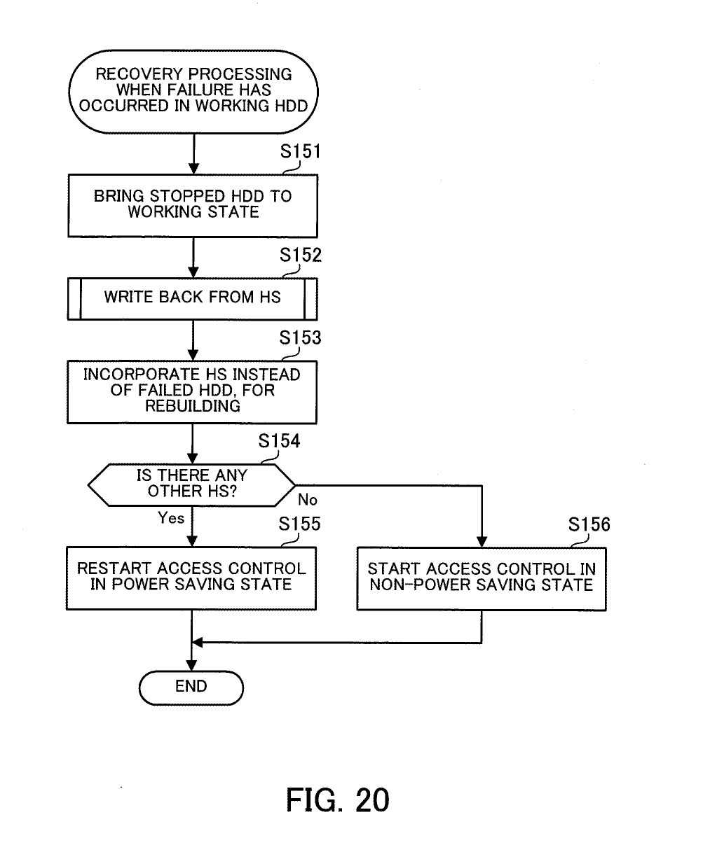

FIG. 20 is the flow chart illustrating an example of the recovery processing when a working HDD among the HDDs constituting a RAID group has failed.

[Step S151] The recovery controller 150 transmits a command for instructing the stopped HDD 211 indicated by the stop disk number registered in the disk management table 180 to rotate the magnetic disk. Thus, the rotation of the magnetic disk is started in each stopped HDD 211, and each stopped HDD 211 transitions to a working state.

[Step S152] The recovery controller 150 causes the write-back controller 140 to write back from the hot spare HDD 212 to the HDD 211 having transitioned to a working state.

[Step S153] The recovery controller 150 incorporates the hot spare HDD 212 to which the write back is completed instead of the failed HDD 211. Specifically, the recovery controller 150 overwrites, for the purpose of registration, the disk number of an HDD 212, which has been used as the hot spare, to a column in which the disk number of the failed HDD 211 has been registered in the RAID management table 190. Moreover, the recovery controller 150 deletes, from the HS disk number in the disk management table 180, the disk number of the HDD 212 that has been used as the hot spare. Thus, the HDD 212 that has been used as the hot spare is changed to an HDD 211 constituting the RAID group.

Furthermore, the recovery controller 150 rebuilds the data to be written in the newly incorporated HDD 211, based on data recorded in another HDD 211, in the RAID group which the failed HDD 211 has been belonging to. Then, the recovery controller 150 writes the rebuilt data to the newly incorporated HDD 211.

[Step S154] The recovery controller 150 determines whether there is any other HDD usable as the hot spare. When there is any HDD usable as the hot spare, the recovery controller 150 registers the disk number of this HDD in the disk management table 180 as an HS disk number, and incorporates this HDD as the hot spare HDD 212. Then, the recovery controller 150 executes processing of step S155. On the other hand, the recovery controller 150 executes processing of step S156 when there is no HDD usable as the hot spare.

[Step S155] The recovery controller 150 causes the RAID controller 130 to resume the access control in a power saving state.

[Step S156] The recovery controller 150 causes the RAID controller 130 to start the access control in a non-power saving state.

According to the above-described process of FIG. 20, the array controller 108 may resume the access control in accordance with an access request from the host for access to the logical volume corresponding to each RAID group even when a working HDD among the HDDs constituting the RAID group has failed.

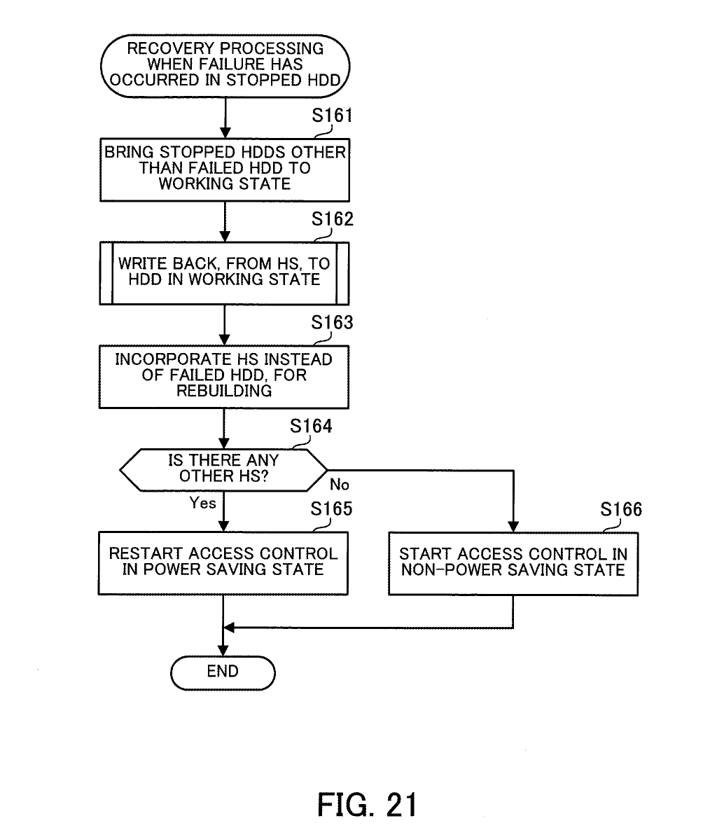

FIG. 21 is the flow chart illustrating an example of the recovery processing when a stopped HDD has failed.

[Step S161] The recovery controller 150 transmits a command for instructing an HDD 211 other than a failed HDD 211 among the stopped HDDs 211 indicated by the stop disk number registered in the disk management table 180 to rotate the magnetic disk. Thus, in each HDD 211 having received the command, the rotation of the magnetic disk is started and each of these HDDs 211 transitions to a working state.

[Step S162] The recovery controller 150 causes the write-back controller 140 to execute the write back from the hot spare HDD 212 to the HDD 211 that transitioned to a working state in step S161. This write-back processing is realized by skipping the write back with the failed HDD 211 as the write destination in the process of FIG. 16.

[Step S163] The recovery controller 150 incorporates the hot spare HDD 212, to which the write back in step S162 is completed instead of the failed HDD 211. Thus, the HDD 212 that has been used as a hot spare is changed to an HDD 211 constituting the RAID group.

Furthermore, the recovery controller 150 rebuilds the data to be written in the newly incorporated HDD 211, based on data recorded in another HDD 211, in the RAID group which the failed HDD 211 has belonged to. Then, the recovery controller 150 writes the rebuilt data to the newly incorporated HDD 211.

[Step S164] The recovery controller 150 determines whether there is any other HDD usable as the hot spare. When there is any HDD usable as the hot spare, the recovery controller 150 registers the disk number of this HDD in the disk management table 180 as an HS disk number, and incorporates this HDD as the hot spare HDD 212. Then, the recovery controller 150 executes processing of step S165. On the other hand, the recovery controller 150 executes processing of step S166 when there is no HDD usable as the hot spare.

[Step S165] The recovery controller 150 causes the RAID controller 130 to resume the access control in a power saving state.

[Step S166] The recovery controller 150 causes the RAID controller 130 to start the access control in a non-power saving state.

According to the above-described process of FIG. 21, the array controller 108 may resume the access control in accordance with an access request from the host for access to the logical volume corresponding to each RAID group even when the stopped HDD among the HDDs constituting the RAID group has failed.

Note that, each processing function of each of the storage control apparatus, information processing apparatus, and array controller inside this information processing apparatus illustrated in the above-described each embodiment may be implemented on a computer. In that case, a program describing the processing content of a function which each device is to have is provided and the program is executed by a computer, so that the above-described processing functions may be realized on the computer. The programs may be stored in a computer-readable medium. Such computer-readable media include magnetic storage devices, optical disks, magneto-optical storage media, semiconductor memory devices, and other non-transitory storage media. The examples of the magnetic storage include a hard disk drive unit (HDD), a flexible disk (FD), and a magnetic tape. The examples of the optical disk include a DVD, a DVD-RAM, a CD-ROM, CD-R/RW, and the like. The examples of the magneto-optical recording medium include an MO (Magneto-Optical disk).

When a program is distributed, portable recording media, such as a DVD and a CD-ROM, on which the program is recorded, are sold, for example. Moreover, network-based distribution of software programs may also be possible, in which case program files are stored in a storage device of a server computer for downloading to other computers via a network.

A computer installs programs in its local storage device, from a portable storage medium or a server computer, so that they may be executed. The computer executes the installed programs while reading them out of its local storage device, thereby performing the programmed functions. Where appropriate, the computer may execute programs immediately from a portable storage medium, without installation. Another alternative method is that the computer executes programs as they are downloaded from a server computer connected via a network.

According to an aspect of the embodiments disclosed herein, in the storage control apparatus, the storage control method, and the storage control program, data may be made redundant with a lower power consumption.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus that controls writing of data to each of one or more logical storage areas each including storage areas of a plurality of storage devices so that the data is made redundant for said each logical storage area in different storage devices, the storage control apparatus comprising a processor configured to execute a process including:
stopping an operation of a plurality of storage devices among the storage devices constituting said each logical storage area;
when writing of data to a stopped storage device is requested among the storage devices constituting said each logical storage area, performing control to maintain data redundancy in said each logical storage area by working storage devices among the storage devices constituting said each logical storage area and by a spare storage device that is different from the storage devices constituting said each logical storage area, by writing the data in the spare storage device instead of the storage device to which the writing is requested.

2. The storage control apparatus according to claim 1, wherein the process further includes:
starting an operation of the stopped storage device among the storage devices constituting said each logical storage area; and
based on write position information in which a write position in any of the storage devices constituting said each logical storage area is registered for each piece of data stored in the spare storage device, writing back the data stored in the spare storage device to a storage area indicated by the corresponding write position.

3. The storage control apparatus according to claim 2, wherein the process further includes:
when writing of data to any of the logical storage areas is requested while writing back the data stored in the spare storage device to the storage area indicated by the corresponding write position is executed, writing the data to a storage device constituting the logical storage area to which the writing is requested, and
when data to be written back to a write destination storage device is stored in the spare storage device, discarding the data.

4. The storage control apparatus according to claim 2,
wherein the writing of data to the spare storage device includes:
when writing of data to a stopped storage device among the storage devices constituting said each logical storage area is requested, writing the write position information indicative of a write position to the stopped storage device requested in the spare storage device in association with the data requested to be written, and registering the write position information also to a predetermined storage area; and
every time writing of data to a same address in a same stopped storage device among the storage devices constituting said each logical storage area is requested, adding the data requested to be written and the write position information associated therewith to the spare storage device, and
wherein the writing back includes:
reading the data written in the spare storage device and the write position information associated therewith in an order opposite to an order of writing to the spare storage device;
when the read write position information is registered also in the predetermined storage area, writing back the data associated with the write position information to a storage area of a storage device indicated by the write position information and also deleting the write position information from the predetermined storage area; and
discarding the data associated with the write position information when the read write position information is not registered in the predetermined storage area.

5. The storage control apparatus according to claim 4, wherein the process further includes:
when writing of data to any of the logical storage areas is requested while writing back the data stored in the spare storage device to a storage area indicated by the corresponding write position is executed, writing the data in a storage device constituting the logical storage area to which the writing is requested, and deleting the write position information from the predetermined storage area when the write position information indicative of a write destination of the data is registered in the predetermined storage area.

6. The storage control apparatus according to claim 4,
wherein the predetermined storage area is a volatile storage area, and
wherein the process further includes: when the write position information registered in the predetermined storage area is lost, reading the write position information associated with the data from the spare storage device, and reregistering the write position information associated with the data in the predetermined storage area.

7. The storage control apparatus according to claim 4,
wherein the predetermined storage area is a volatile storage area, and
wherein the process further includes:
when the write position information registered in the predetermined storage area is lost, reading the data written in the spare storage device and the write position information associated therewith in an order opposite to an order of writing to the spare storage device; and
when the read write position information is not registered in the predetermined storage area, writing back data associated with the write position information to a storage area of a storage device indicated by the write position information and registering the write position information to the predetermined storage area, and
discarding the data associated with the write position information when the read write position information is registered also in the predetermined storage area.

8. The storage control apparatus according to claim 2, wherein the writing back includes, when a remaining capacity of the spare storage device becomes smaller than a predetermined threshold, writing back the data stored in the spare storage device to a storage area indicated by the corresponding write position.

9. A storage control method in a storage control apparatus that controls writing of data to each of one or more logical storage areas each including storage areas of a plurality of storage devices so that the data is made redundant for said each logical storage area in different storage devices, the method comprising:
stopping an operation of a plurality of storage devices among the storage devices constituting said each logical storage area;
when writing of data to a stopped storage device is requested among the storage devices constituting said each logical storage area, performing control to maintain data redundancy in said each logical storage area by working storage devices among the storage devices constituting said each logical storage area and by a spare storage device that is different from the storage devices constituting said each logical storage area, by writing the data in the spare storage device instead of the storage device to which the writing is requested.

10. The storage control method according to claim 9, further comprising:
starting an operation of the stopped storage device among the storage devices constituting said each logical storage area; and
based on write position information in which a write position in any of the storage devices constituting said each logical storage area is registered for each piece of data stored in the spare storage device, writing back the data stored in the spare storage device to a storage area indicated by the corresponding write position.
